(19) United States
(12) Patent Application Publication
(10) Pub. No.: US 2025/0246152 A1
(43) Pub. Date: Jul. 31, 2025

(54) SCAN DRIVING CIRCUIT AND DISPLAY DEVICE

(71) Applicant: Samsung Display Co., Ltd., Yongin-Si (KR)

(72) Inventors: KEUK-JIN JEONG, Yongin-si (KR); WONGYUN KIM, Yongin-si (KR); MIN KANG, Yongin-si (KR)

(21) Appl. No.: 19/011,631

(22) Filed: Jan. 7, 2025

(30) Foreign Application Priority Data
Jan. 25, 2024 (KR) 10-2024-0011863

(51) Int. Cl. G09G 3/3266; G09G 3/3275

(52) U.S. Cl. CPC G09G 3/3266; G09G 3/3275; G09G 2300/0871; G09G 2310/0289; G09G 2310/08

(57) ABSTRACT

Disclosed is a scan driving circuit of a display device including an input circuit, second and third transistors, and first and second capacitors. The input circuit is connected between a carry input terminal and a first node and operates in response to a first clock signal received through a first clock input terminal. The second transistor is connected between a first voltage terminal and an output terminal and includes a gate electrode connected to the first clock input terminal. The third transistor is connected between the output terminal and a second clock input terminal and includes a gate electrode connected to the first node. The first capacitor is connected between the output terminal and the first node. The second capacitor is connected between the first node and a second voltage terminal.

### CROSS-REFERENCE TO RELATED APPLICATIONS

This application claims priority under 35 U.S.C. § 119 to Korean Patent Application No. 10-2024-0011863 filed on Jan. 25, 2024, in the Korean Intellectual Property Office, the disclosure of which is incorporated by reference herein in its entirety.

### BACKGROUND

Embodiments of the present disclosure described herein relate to a display device, and more particularly, relate to a display device including a scan driving circuit.

A display device includes pixels connected to data lines and scan lines. Each of the pixels includes a light emitting element and a pixel circuit for controlling the light emitting element. The pixel circuit may provide a current corresponding to a data signal to the light emitting element. At this time, light having predetermined luminance may be generated in response to a current flowing through the light emitting element.

A scan driving circuit outputs scan signals to sequentially drive the scan lines.

### SUMMARY

Embodiments of the present disclosure may provide a scan driving circuit capable of minimizing a circuit area and a display device including the same.

According to an embodiment, a scan driving circuit includes an input circuit connected between a carry input terminal and a first node and operating in response to a first clock signal received through a first clock input terminal, a second transistor connected between a first voltage terminal and an output terminal and including a gate electrode connected to the first clock input terminal, a third transistor connected between the output terminal and a second clock input terminal and including a gate electrode connected to the first node, a first capacitor connected between the output terminal and the first node, and a second capacitor connected between the first node and a second voltage terminal.

In an embodiment, a first voltage provided to the first voltage terminal may have a higher voltage level than a second voltage provided to the second voltage terminal.

In an embodiment, a first clock signal provided to the first clock input terminal and a second clock signal provided to the second clock input terminal may have frequencies the same as each other and different phases from each other.

In an embodiment, during a first period, each of a carry signal provided to the carry input terminal and the first clock signal may be at a first level. During a second period different from the first period, the second clock signal may be at the first level. During the second period, a scan signal output to the output terminal may be at the first level the same as the second clock signal.

In an embodiment, the input circuit may be connected between the carry input terminal and the first node, and may include a gate electrode connected to the first clock input terminal.

In an embodiment, the input circuit may include 1-1st and 1-2nd transistors, which are sequentially connected in series between the carry input terminal and the first node, and each of which includes a gate electrode connected to the first clock input terminal.

In an embodiment, the input circuit may further include 1-1st and 1-2nd transistors, which are sequentially connected in series between the carry input terminal and a second node, and each of which includes a gate electrode connected to the first clock input terminal, and a fourth transistor connected between the first node and the second node and including a gate electrode connected to the second voltage terminal.

In an embodiment, the scan driving circuit may further include a fourth transistor connected between the first clock input terminal and the first node and includes a gate electrode connected to the carry input terminal.

In an embodiment, the scan driving circuit may further include a fourth transistor connected between the first clock input terminal and a second node and including a gate electrode connected to the carry input terminal, and a fifth transistor connected between the second node and the first node and including a gate electrode connected to the second voltage terminal.

In an embodiment, the input circuit may include a first transistor connected between the carry input terminal and the first node and including a gate electrode connected to a second node, a fourth transistor connected between a third voltage terminal and the second node and including a gate electrode connected to the first clock input terminal, and a fifth transistor connected between a fourth voltage terminal and the second node and including a gate electrode connected to the first clock input terminal.

In an embodiment, a first voltage provided to the first voltage terminal may have a higher voltage level than a second voltage provided to the second voltage terminal. A third voltage provided to the third voltage terminal may have a higher voltage level than the first voltage. A fourth voltage provided to the fourth voltage terminal may have a voltage level lower than the second voltage.

In an embodiment, the input circuit may include a first transistor connected between the carry input terminal and a third node and including a gate electrode connected to a second node, a fourth transistor connected between a third voltage terminal and the second node and including a gate electrode connected to the first clock input terminal, a fifth transistor connected between a fourth voltage terminal and the second node and including a gate electrode connected to the first clock input terminal, and a sixth transistor connected between the third node and the first node and including a gate electrode connected to the second voltage terminal.

In an embodiment, a first voltage provided to the first voltage terminal may have a higher voltage level than a second voltage provided to the second voltage terminal. A third voltage provided to the third voltage terminal may have a higher voltage level than the first voltage. A fourth voltage provided to the fourth voltage terminal may have a voltage level lower than the second voltage.

In an embodiment, the input circuit may include a first transistor connected between a second node and the second voltage terminal and including a gate electrode connected to the carry input terminal, a fourth transistor connected between the carry input terminal and the second node and including a gate electrode connected to the first clock input terminal, and a fifth transistor connected between the second node and the first node and including a gate electrode connected to the second voltage terminal.

According to an embodiment, a display device includes a display panel including a pixel, a scan driving circuit that provides a scan signal to the pixel, a driving controller that provides a start signal, a first clock signal, and a second clock signal to the scan driving circuit, and a voltage generator that provides a first voltage and a second voltage to the scan driving circuit. The scan driving circuit includes an input circuit connected between a carry input terminal for receiving the start signal and a first node, and operating in response to a first clock signal received through a first clock input terminal, a second transistor connected between a first voltage terminal for receiving the first voltage and an output terminal outputting the scan signal, and including a gate electrode connected to the first clock input terminal, a third transistor connected between the output terminal and the second clock input terminal for receiving the second clock signal, and including a gate electrode connected to the first node, a first capacitor connected between the output terminal and the first node, and a second capacitor connected between the first node and a second voltage terminal for receiving the second voltage.

In an embodiment, during a first period, each of the start signal and the first clock signal may be at a first level. During a second period different from the first period, the second clock signal may be at the first level. During the second period, the scan signal may be at the first level the same as the second clock signal.

In an embodiment, the input circuit may be connected between the carry input terminal and the first node, and may include a gate electrode connected to the first clock input terminal.

In an embodiment, the scan driving circuit may further include a fourth transistor is connected between the first clock input terminal and the first node and includes a gate electrode connected to the carry input terminal.

In an embodiment, the input circuit may include a first transistor connected between the carry input terminal and the first node and including a gate electrode connected to a second node, a fourth transistor connected between a third voltage terminal and the second node and including a gate electrode connected to the first clock input terminal, and a fifth transistor connected between a fourth voltage terminal and the second node and including a gate electrode connected to the first clock input terminal.

In an embodiment, the display device may further include a data driving circuit that provides a data signal. The pixel may include a light emitting element, a first pixel transistor including a first electrode, a second electrode connected to the light emitting element, and a gate electrode, and a second pixel transistor connected between a data line for receiving the data signal and the first electrode of the first transistor and including a gate electrode for receiving the scan signal.

### BRIEF DESCRIPTION OF THE FIGURES

The above and other objects and features of the present disclosure will become apparent by describing in detail embodiments thereof with reference to the accompanying drawings.

FIG. 1 illustrates a display device, according to an embodiment of the present disclosure.

FIG. 2 is a block diagram of a display device, according to an embodiment of the present disclosure.

FIG. 3 is a circuit diagram of a pixel, according to an embodiment of the present disclosure.

FIG. 4 is a timing diagram for describing an operation of the pixel shown in FIG. 3.

FIG. 5 is a block diagram of a scan driving circuit, according to an embodiment of the present disclosure.

FIG. 6 is a block diagram of a first scan driving circuit, according to an embodiment of the present disclosure.

FIG. 7 is a circuit diagram of a driving stage, according to an embodiment of the present disclosure.

FIGS. 8A to 8E are circuit diagrams for describing an operation of a driving stage.

FIGS. 9A to 9E are timing diagrams for describing an operation of a driving stage.

FIG. 10 is a circuit diagram of a driving stage, according to an embodiment of the present disclosure.

FIG. 11 is a circuit diagram of a driving stage, according to an embodiment of the present disclosure.

FIG. 12 is a circuit diagram of a driving stage, according to an embodiment of the present disclosure.

FIGS. 13A to 13E are circuit diagrams for describing an operation of the driving stage illustrated in FIG. 12.

FIG. 14 is a circuit diagram of a driving stage, according to an embodiment of the present disclosure.

FIG. 15 is a circuit diagram of a driving stage, according to an embodiment of the present disclosure.

FIG. 16 is a circuit diagram of a driving stage, according to an embodiment of the present disclosure.

FIGS. 17A to 17E are circuit diagrams for describing an operation of a driving stage illustrated in FIG. 16.

FIG. 18 is a circuit diagram of a driving stage, according to an embodiment of the present disclosure.

FIG. 19 is a circuit diagram of a driving stage, according to an embodiment of the present disclosure.

FIGS. 20A to 20E are circuit diagrams for describing an operation of the driving stage illustrated in FIG. 19.

### DETAILED DESCRIPTION

In the specification, the expression that a first component (or region, layer, part, etc.) is “on”, “connected with”, or “coupled with” a second component means that the first component is directly on, connected with, or coupled with the second component or means that a third component is interposed therebetween.

Like reference numerals refer to like components. Also, in drawings, the thickness, ratio, and dimension of components are exaggerated for effectiveness of description of technical contents.

Although the terms “first”, “second”, etc. may be used to describe various components, the components should not be construed as being limited by the terms. The terms are only used to distinguish one component from another component. For example, without departing from the scope and spirit of the present disclosure, a first component may be referred to as a second component, and similarly, the second component may be referred to as the first component. The articles “a,” “an,” and “the” are singular in that they have a single referent, but the use of the singular form in the specification should not preclude the presence of more than one referent.

Also, the terms “under”, “beneath”, “on”, “above”, etc. are used to describe a relationship between components illustrated in a drawing. The terms are relative and are described with reference to a direction indicated in the drawing.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Unless otherwise defined, all terms (including technical terms and scientific terms) used in this specification have the same meaning as commonly understood by those skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the present disclosure will be described with reference to accompanying drawings.

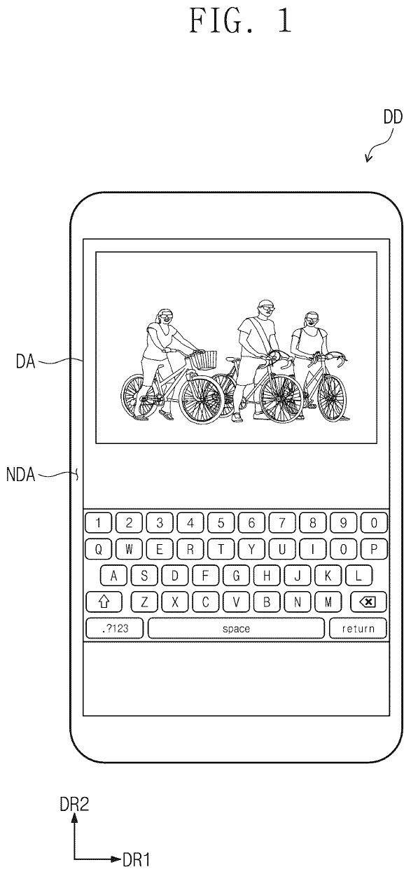

FIG. 1 shows a display device DD, according to an embodiment of the present disclosure.

Referring to FIG. 1, a portable terminal is illustrated as an example of a display device DD according to an embodiment of the present disclosure. The portable terminal may include a tablet PC, a smartphone, a personal digital assistant (PDA), a portable multimedia player (PMP), a game console, a wristwatch-type electronic device, and the like. However, the present disclosure is not limited thereto. The present disclosure may be used for small and medium electronic devices such as a personal computer, a notebook computer, a kiosk, a car navigation unit, and a camera, in addition to large-sized electronic equipment such as a television or an outside billboard. The above examples are provided only as an embodiment, and it is obvious that the display device DD may be applied to any other electronic device(s) without departing from the concept of the present disclosure.

As shown in FIG. 1, a display surface, on which an image is displayed, is parallel to a plane defined by a first direction DR1 and a second direction DR2. The display device DD includes a plurality of areas separated on the display surface. The display surface includes a display area DA, in which the image is displayed, and a non-display area NDA adjacent to the display area DA. The non-display area NDA may be referred to as a bezel area. For example, the display area DA may have a rectangular shape. The non-display area NDA surrounds the display area DA. Also, although not illustrated, for example, the display device DD may include a shape thus partially curved.

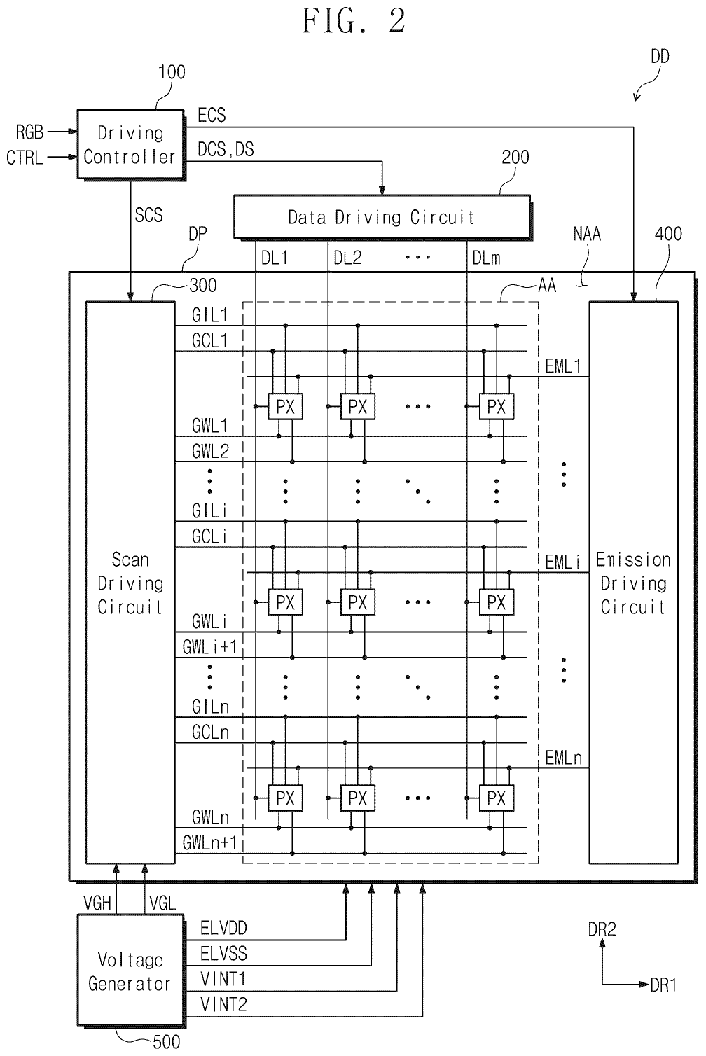

FIG. 2 is a block diagram of the display device DD, according to an embodiment of the present disclosure.

Referring to FIG. 2, the display device DD includes a display panel DP, a driving controller 100, a data driving circuit 200, a scan driving circuit 300, an emission driving circuit 400, and a voltage generator 500.

The driving controller 100 receives an image signal RGB and a control signal CTRL. The driving controller 100 converts the image signal RGB into an image data signal DS and outputs the image data signal DS. The driving controller 100 outputs a scan control signal SCS, a data control signal DCS, and an emission control signal ECS.

The data driving circuit 200 receives the data control signal DCS and the image data signal DS from the driving controller 100. The data driving circuit 200 converts the image data signal DS into data signals and then outputs the data signals to a plurality of data lines DL1 to DLm to be described later.

The scan driving circuit 300 receives the scan control signal SCS from the driving controller 100. The scan driving circuit 300 may output scan signals to the scan lines GIL1 to GILn, GCL1 to GCLn, and GWL1 to GWLn+1 in response to the scan control signal SCS.

The emission driving circuit 400 receives the emission control signal ECS from the driving controller 100. The emission driving circuit 400 may output emission signals to the emission lines EML1 to EMLn in response to the emission control signal ECS.

The voltage generator 500 generates voltages to operate the display panel DP. In an embodiment, the voltage generator 500 may generate a first driving voltage ELVDD, a second driving voltage ELVSS, a first initialization voltage VINT1, and a second initialization voltage VINT2 for an operation of the display panel DP. In an embodiment, the voltage generator 500 may generate a first voltage VGH and a second voltage VGL for the operation of the scan driving circuit 300.

The display panel DP includes the scan lines GIL1 to GILn, GCL1 to GCLn, and GWL1 to GWLn+1, the emission lines EML1 to EMLn, the data lines DL1 to DLm, and pixels PX.

The display panel DP includes an active area AA and an inactive area NAA. The active area AA may correspond to the display area DA of the display device DD shown in FIG. 1, and the inactive area NAA may correspond to the non-display area NDA.

In an embodiment, the pixels PX may be placed in the active area AA of the display panel DP. The scan driving circuit 300 and the emission driving circuit 400 may be placed in the inactive area NAA of the display panel DP. In an embodiment, the scan driving circuit 300 is arranged adjacent to a first side of the active area AA. The scan lines GIL1 to GILn, GCL1 to GCLn, and GWL1 to GWLn+1 extend from the scan driving circuit 300 in the first direction DR1. The emission driving circuit 400 is arranged adjacent to the second side of the active area AA. The emission lines EML1 to EMLn extend from the emission driving circuit 400 in a direction opposite to the first direction DR1.

The scan lines GIL1 to GILn, GCL1 to GCLn, and GWL1 to GWLn+1 and the emission lines EML1 to EMLn are arranged spaced from one another in the second direction DR2. The data lines DL1 to DLm extend from the data driving circuit 200 in a direction opposite to the second direction DR2, and are arranged spaced from one another in the first direction DR1.

In the example shown in FIG. 2, the scan driving circuit 300 and the emission driving circuit 400 are arranged to face each other with the pixels PX interposed therebetween, but the present disclosure is not limited thereto. For example, the scan driving circuit 300 and the emission driving circuit 400 may be placed adjacent to each other in the inactive area NAA of the display panel DP. In an embodiment, the scan driving circuit 300 and the emission driving circuit 400 may be implemented with one circuit.

The plurality of pixels PX are electrically connected to the scan lines GIL1 to GILn, GCL1 to GCLn, and GWL1 to GWLn+1, the emission lines EML1 to EMLn, and the data lines DL1 to DLm. Each of the plurality of pixels PX may be electrically connected to four scan lines and one emission line. For example, as shown in FIG. 2, a first row of pixels may be connected to the scan lines GIL1, GCL1, GWL1, and GWL2 and the emission line EML1. Furthermore, the i-th row of pixels may be connected to the scan lines GILi, GCLi, GWLi, and GWLi+1 and the emission line EMLi. The n-th row of pixels in may be connected to the scan lines GILn, GCLn, GWLn, and GWLn+1 and the emission line EMLn.

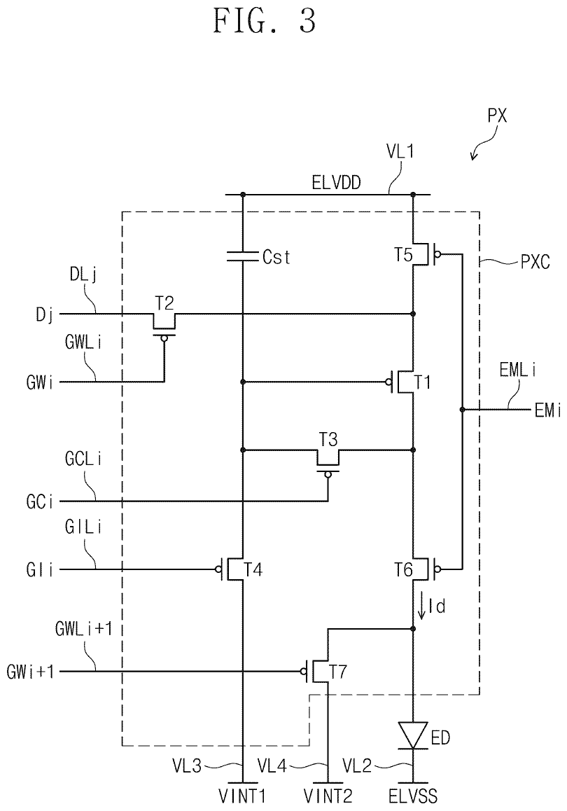

Each of the plurality of pixels PX includes a light emitting element ED (see FIG. 3) and a pixel circuit PXC (see FIG. 3) for controlling the emission of the light emitting element ED. The pixel circuit PXC may include one or more transistors and one or more capacitors. The scan driving circuit 300 and the emission driving circuit 400 may include transistors formed through the same process as the pixel circuit PXC.

The scan driving circuit 300 according to an embodiment of the present disclosure is placed in the inactive area NAA of the display panel DP. The scan driving circuit 300 according to an embodiment of the present disclosure may minimize the circuit area by including a minimum number of transistors. Accordingly, it is possible to minimize the area of the non-display area NDA of the display device DD (see FIG. 1) corresponding to the inactive area NAA of the display panel DP.

FIG. 3 is a circuit diagram of a pixel PX, according to an embodiment of the present disclosure.

FIG. 3 illustrates a circuit diagram of a pixel PX connected to the j-th data line DLj among the data lines DL1 to DLm, the i-th scan lines GILi, GCLi, and GWLi and the (i+1)-th scan line GWLi+1 among the scan lines GIL1 to GILn, GCL1 to GCLn, and GWL1 to GWLn+1, and the i-th emission line EMLi among the emission lines EML1 to EMLn, which are illustrated in FIG. 2.

Each of the plurality of pixels PX shown in FIG. 2 may have the same circuit configuration as the pixel PX shown in FIG. 3.

Referring to FIG. 3, the pixel PX of a display device according to an embodiment includes the pixel circuit PXC and the at least one light emitting element ED. In an embodiment, the light emitting element ED may be a light emitting diode. In an embodiment, it is described that the one pixel PX includes the one light emitting element ED. The pixel circuit PXC includes first to seventh transistors T1, T2, T3, T4, T5, T6, and T7 and a capacitor Cst.

In an embodiment, each of the first to seventh transistors T1 to T7 is a P-type transistor having a low-temperature polycrystalline silicon (LTPS) semiconductor layer. However, the present disclosure is not limited thereto. For example, each of the first to seventh transistors T1 to T7 may be an N-type transistor using an oxide semiconductor as a semiconductor layer.

In an embodiment, at least one of the first to seventh transistors T1 to T7 may be an N-type transistor, and the other(s) thereof may be P-type transistors. Moreover, a circuit configuration of the pixel PX according to an embodiment of the present disclosure is not limited to an embodiment in FIG. 3, and may be implemented in a modified manner.

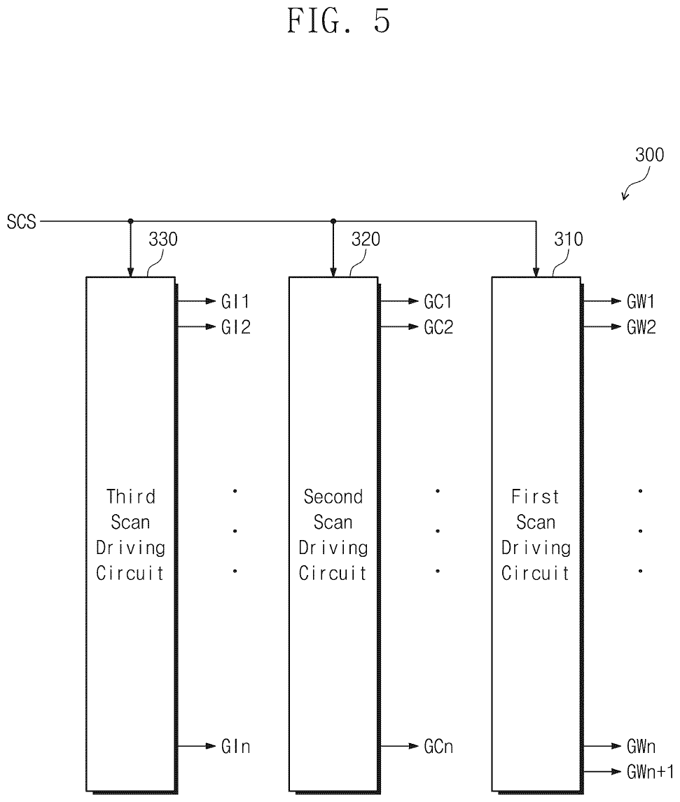

The scan lines GILi, GCLi, GWLi, and GWLi+1 may deliver scan signals GIi, GCi, GWi, and GWi+1, respectively. The emission line EMLi may deliver an emission signal EMi. The data line DLj delivers a data signal Dj. The data signal Dj may have a voltage level corresponding to the image signal RGB input to the display device DD (see FIG. 5). First to fourth driving voltage lines VL1, VL2, VL3, and VL4 may transfer the first driving voltage ELVDD, the second driving voltage ELVSS, the first initialization voltage VINT1, and the second initialization voltage VINT2, respectively.

The first transistor T1 includes a first electrode connected to the first driving voltage line VL1 via the fifth transistor T5, a second electrode electrically connected to an anode of the light emitting element ED via the sixth transistor T6, and a gate electrode connected to one end of the capacitor Cst. The first transistor T1 may receive the data signal Dj delivered through the data line DLj depending on the switching operation of the second transistor T2 and then may supply a driving current Id to the light emitting element ED.

The second transistor T2 includes a first electrode connected to the data line DLj, a second electrode connected to the first electrode of the first transistor T1, and a gate electrode connected to the scan line GWLi. The second transistor T2 may be turned on in response to the scan signal GWi transferred through the scan line GWLi and may transfer the data signal Dj transferred through the data line DLj to the first electrode of the first transistor T1.

The third transistor T3 includes a first electrode connected with the gate electrode of the first transistor Tl, a second electrode connected with the second electrode of the first transistor T1, and a gate electrode connected with the scan line GCLi. The third transistor T3 may be turned on in response to the scan signal GCi transferred through the scan line GCLi, and thus, the gate electrode and the second electrode of the first transistor T1 may be connected, that is, the first transistor T1 may be diode-connected.

The fourth transistor T4 includes a first electrode connected with the gate electrode of the first transistor T1, a second electrode connected with the third driving voltage line VL3 through which the first initialization voltage VINT1 is transferred, and a gate electrode connected with the scan line GILi. The fourth transistor T4 may be turned on in response to the scan signal GIi transferred through the scan line GILi such that the first initialization voltage VINT1 is transferred to the gate electrode of the first transistor T1. Accordingly, an initialization operation of initializing a voltage of the gate electrode of the first transistor T1 may be performed.

The fifth transistor T5 includes a first electrode connected to the first driving voltage line VL1, a second electrode connected to the first electrode of the first transistor T1, and a gate electrode connected to the emission line EMLi.

The sixth transistor T6 includes a first electrode connected to the second electrode of the first transistor T1, a second electrode connected with the anode of the light emitting element ED, and a gate electrode connected to the emission line EMLi.

The fifth transistor T5 and the sixth transistor T6 may be simultaneously turned on in response to the emission signal EMi transferred through the emission line EMLi. In this way, the first driving voltage ELVDD may be compensated for through the diode-connected transistor T1 so as to be supplied to the light emitting element ED.

The seventh transistor T7 includes a first electrode connected to the second electrode of the sixth transistor T6, a second electrode connected to the fourth driving voltage line VLA, and a gate electrode connected to the scan line GWLi+1. The seventh transistor T7 is turned on in response to the scan signal GWi+1 transferred through the scan line GWLi+1 and bypasses a current of the anode of the light emitting element ED to the fourth voltage line VL4.

As described above, one end of the capacitor Cst is connected to the gate electrode of the first transistor T1, and the other end of the capacitor Cst is connected to the first driving voltage line VL1. The cathode of the light emitting element ED may be connected to the second driving voltage line VL2, to which the second driving voltage ELVSS is delivered. The pixel circuit PXC according to an embodiment is not limited to that shown in FIG. 3. The number of transistors included in the pixel circuit PXC, the number of capacitors, and the connection relationship thereof may be modified in various manners.

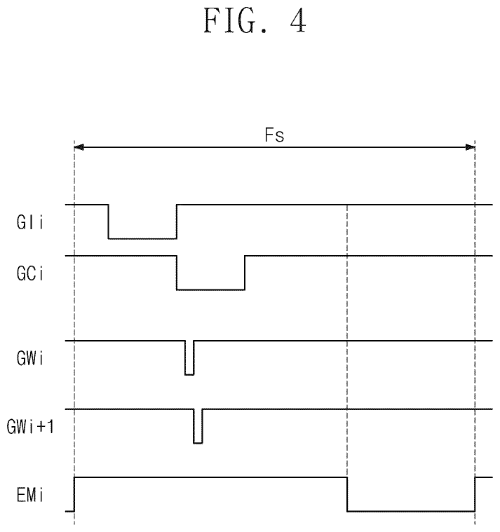

FIG. 4 is a timing diagram for describing an operation of the pixel shown in FIG. 3.

Referring to FIGS. 3 and 4, one frame Fs may include an initialization period, a data programming and compensation period, and an emission period.

When the scan signal GIi having a low level is provided through the scan line GILi during the initialization period, the fourth transistor T4 is turned on. The first initialization voltage VINT1 is delivered to the gate electrode of the first transistor T1 through the fourth transistor T4 so as to initialize the first transistor T1.

Next, when the scan signal GCi having a low level is supplied through the scan line GCLi during the data programming and compensation period, the third transistor T3 is turned on. The first transistor T1 is diode-connected by the third transistor T3 thus turned on to be forward-biased. At this time, when the scan signal GWi having a low level is supplied through the scan line GWLi, the second transistor T2 is turned on. In the case, a compensation voltage, which is obtained by reducing the voltage of the data signal Dj supplied from the data line DLj by a threshold voltage of the first transistor T1, is applied to the gate electrode of the first transistor T1. That is, a gate voltage applied to the gate electrode of the first transistor T1 may be a compensation voltage.

As the first driving voltage ELVDD and the compensation voltage are respectively applied to opposite ends of the capacitor Cst, charges corresponding to a difference between the first driving voltage ELVDD and the compensation voltage may be stored in the capacitor Cst.

In the meantime, when the scan signal GWi+1 having a low level is provided to the gate electrode of the seventh transistor T7 through the scan line GWLi+1, the seventh transistor T7 is turned on. As the seventh transistor T7 is turned on, the anode of the light emitting element ED is electrically connected to the fourth driving voltage line VL4. Accordingly, the anode of the light emitting element ED may be initialized to the second initialization voltage VINT2.

Next, during the emission period, the emission signal EMi supplied from the emission line EMLi is changed from a high level to a low level. During the emission period, the fifth transistor T5 and the sixth transistor T6 are turned on by the emission signal EMi having a low level. In this case, the driving current Id according to a voltage difference between the gate voltage of the gate electrode of the first transistor T1 and the first driving voltage ELVDD is generated and supplied to the light emitting element ED through the sixth transistor T6, and the driving current Id flows through the light emitting element ED. The light emitting element ED may emit light with luminance corresponding to the driving current Id.

FIG. 5 is a block diagram of the scan driving circuit 300, according to an embodiment of the present disclosure.

Referring to FIG. 5, the scan driving circuit 300 includes a first scan driving circuit 310, a second scan driving circuit 320, and a third scan driving circuit 330.

The first scan driving circuit 310 outputs scan signals GW1 to GWn+1 in response to the scan control signal SCS. In an embodiment, the scan signals GW1 to GWn+1 may sequentially transition to a first level (e.g., a low level).

The second scan driving circuit 320 outputs scan signals GC1 to GCn in response to the scan control signal SCS. The scan signals GC1 to GCn may sequentially transition to the first level (e.g., a low level).

The third scan driving circuit 330 outputs the scan signals GI1 to GIn in response to the scan control signal SCS. The scan signals GI1 to GIn may sequentially transition to the first level (e.g., a low level).

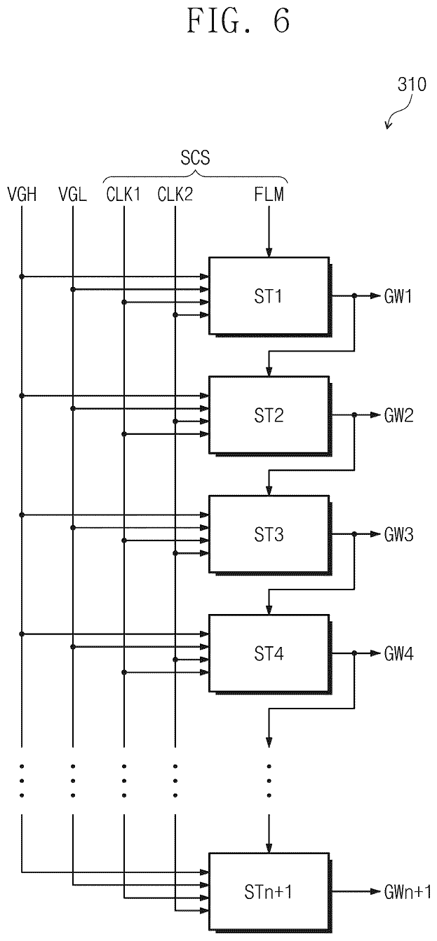

FIG. 6 is a block diagram of the first scan driving circuit 310, according to an embodiment of the present disclosure.

Referring to FIG. 6, the first scan driving circuit 310 includes driving stages ST1 to STn+1.

The driving stages ST1 to STn+1 receive the scan control signal SCS from the driving controller 100 shown in FIG. 2. The scan control signal SCS includes a start signal FLM, a first clock signal CLK1, and a second clock signal CLK2. Each of the driving stages ST1 to STn+1 receives the first clock signal CLK1 and the second clock signal CLK2. Each of the driving stage ST1 to STn+1 receives the first voltage VGH and the second voltage VGL. The first voltage VGH and the second voltage VGL may be provided from the voltage generator 500 illustrated in FIG. 2.

In an embodiment, the driving stage ST1 to STn+1 output the scan signals GW1 to GWn+1, respectively. The scan signals GW1 to GWn+1 may be provided to the scan lines GWL1 to GWLn+1 shown in FIG. 2, respectively.

The driving stage ST1 receives the start signal FLM as a carry signal. Each of the driving stages ST2 to STn+1 has a dependent connection relationship indicating that the scan signal output from the previous driving stage is received as the carry signal. For example, the scan signal GWi output from the i-th driving stage STi among the driving stages may be provided as a carry signal of the (i+k)-th driving stage STi+k (each of ‘i’ and ‘k’ is a natural number). For example, the second driving stage ST2 receives the scan signal GW1 output from the first driving stage ST1 as a carry signal. The third driving stage ST3 receives the scan signal GW2 output from the second driving stage ST2 as a carry signal. FIG. 6 shows that the i-th driving stage STi receives a scan signal from the (i−1)-th driving stage STi-1 as a carry signal, but the present disclosure is not limited thereto.

Although only the first scan driving circuit 310 is shown in FIG. 6, the second scan driving circuit 320 and the third scan driving circuit 330 shown in FIG. 5 may also include the same components as the first scan driving circuit 310.

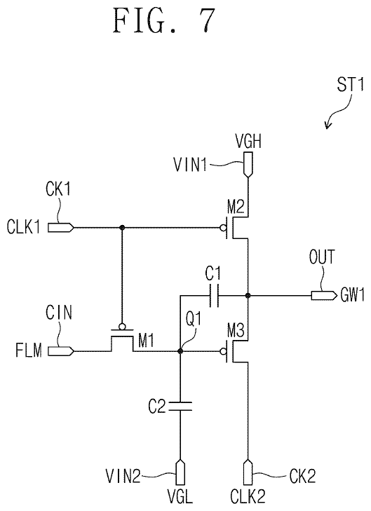

FIG. 7 is a circuit diagram of a driving stage ST1, according to an embodiment of the present disclosure.

Referring to FIG. 7, the driving stage ST1 includes first, second, and third transistors M1, M2, and M3 and first and second capacitors C1 and C2. Moreover, the driving stage ST1 further includes first and second clock input terminals CK1 and CK2, a carry input terminal CIN, first and second voltage terminals VIN1 and VIN2, and an output terminal OUT.

The driving stage ST1 outputs the scan signal GW1 to the output terminal OUT in response to the first and second clock signals CLK1 and CLK2, which are received through the first and second clock input terminals CK1 and CK2, and the carry signal received through the carry input terminal CIN (i.e., the start signal FLM).

Each of the first and second voltages VGH and VGL received through the first and second voltage terminals VIN1 and VIN2 may be a direct current (DC) voltage having a predetermined voltage level. In an embodiment, the first voltage VGH may have a higher voltage level than the second voltage VGL.

In an embodiment, the first transistor M1 may be connected between the carry input terminal CIN and a first node Q1, and may be referred to as an input circuit that operates in response to the first clock signal received through the first clock input terminal CK1.

In an embodiment, the first and second clock signals CLK1 and CLK2 may have the same frequency as each other and different phases from each other.

The first transistor M1 may be connected between the carry input terminal CIN and the first node Q1, and may include a gate electrode connected to the first clock input terminal CK1.

The second transistor M2 may be connected between the first voltage terminal VIN1 and the output terminal OUT, and may include a gate electrode connected to the first clock input terminal CK1.

The third transistor M3 may be connected between the output terminal OUT and the second clock input terminal CK2 and may include a gate electrode connected to the first node Q1.

The first capacitor C1 is connected between the first node Q1 and the output terminal OUT.

The second capacitor C2 is connected between the first node Q1 and the second voltage terminal VIN2.

In an embodiment, each of the first, second, and third transistors M1, M2, and M3 is a P-type transistor having a low-temperature polycrystalline silicon (LTPS) semiconductor layer. However, the present disclosure is not limited thereto. In an embodiment, at least one of the first, second, and third transistors M1, M2, and M3 may be a P-type transistor, and the others may be N-type transistors using an oxide semiconductor as a semiconductor layer. In an embodiment, all of the first, second, and third transistors M1, M2, and M3 may be N-type transistors.

The driving stage ST1 may include three transistors (i.e., the first, second, and third transistors M1, M2, and M3) and two capacitors (i.e., the first and second capacitors C1 and C2) to output the scan signal GW1. The circuit area of the scan driving circuit 300 (see FIG. 2) may be minimized by minimizing the number of transistors and of capacitors, which are included in the driving stage ST1.

Although only the driving stage ST1 is shown in FIG. 7, each of the driving stages ST1 to STn+1 shown in FIG. 6 may include a circuit configuration similar to the driving stage ST1 shown in FIG. 7.

Each of some driving stages (e.g., the odd-numbered driving stages ST1, ST3, . . . , and STn+1) of the driving stage ST1 to STn+1 shown in FIG. 6 may include the same circuit configuration as the driving stage ST1 shown in FIG. 7.

Each of the other driving stages (e.g., even-numbered driving stages ST2, ST4, . . . , and STn) among the driving stages ST1 to STn+1 shown in FIG. 6 may include some different circuit configurations from the driving stage ST1 shown in FIG. 7. For example, the first clock input terminal CK1 of each of the even-numbered driving stage ST2, ST4, . . . , and STn may receive the second clock signal CLK2, and the second clock input terminal CK2 thereof may receive the first clock signal CLK1.

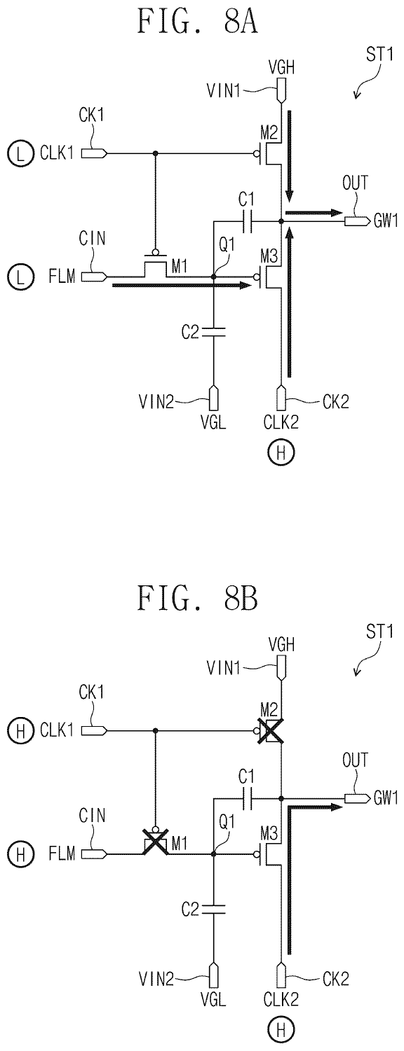

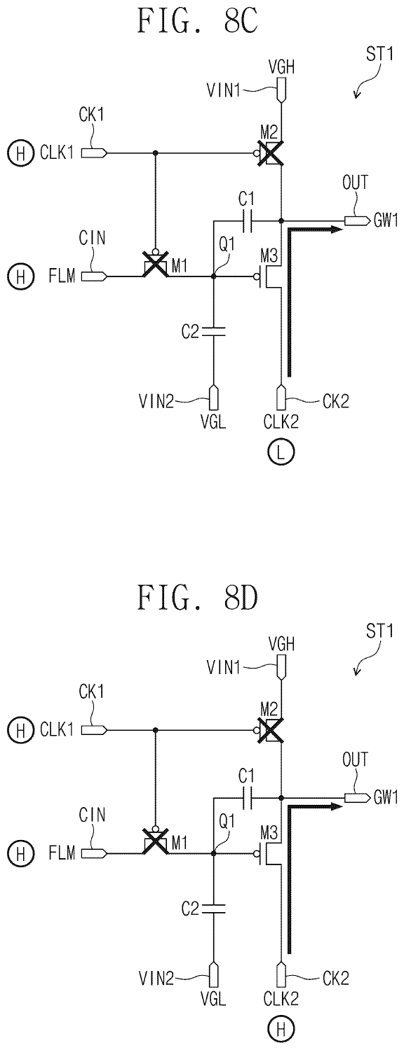

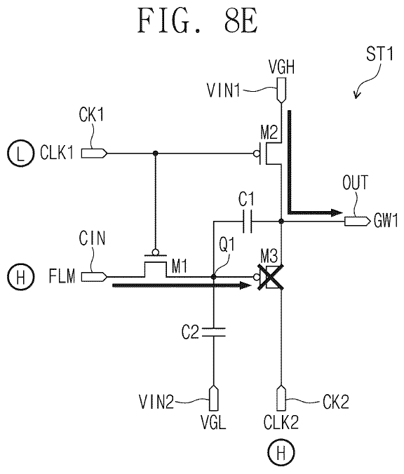

FIGS. 8A to 8E are circuit diagrams for describing an operation of the driving stage ST1.

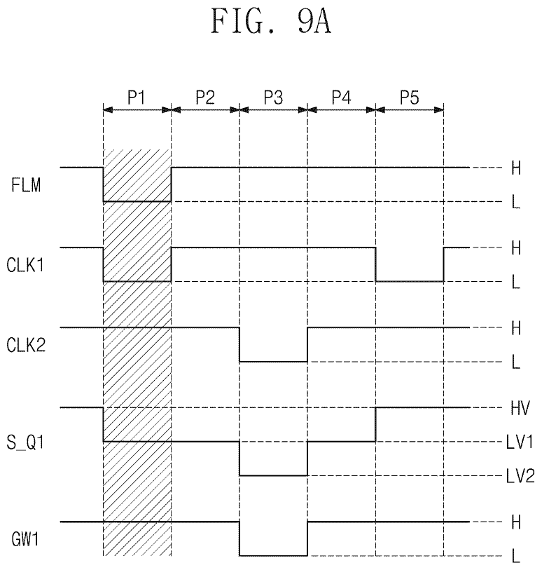

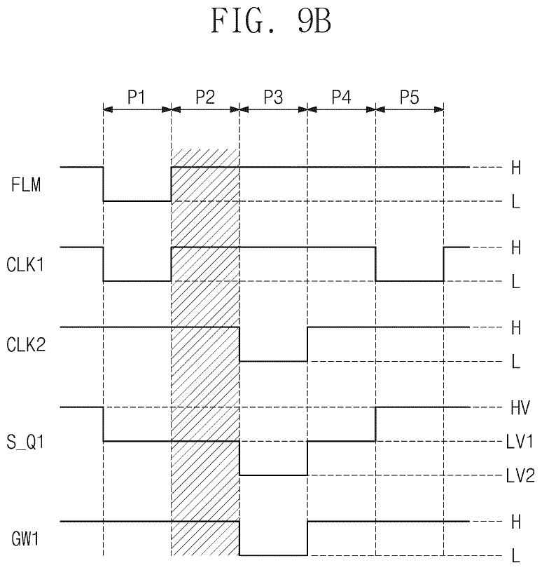

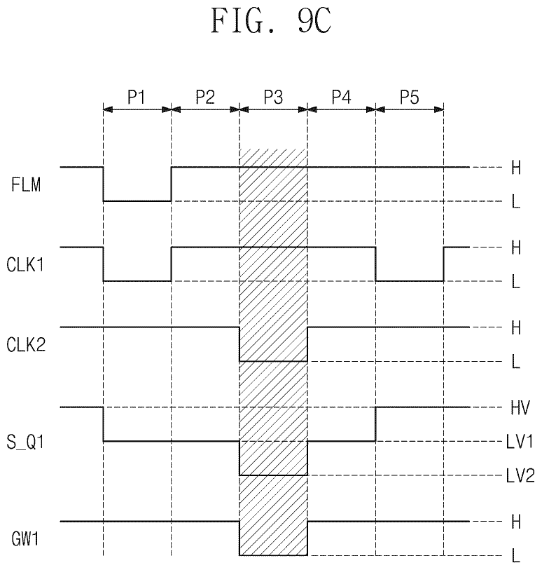

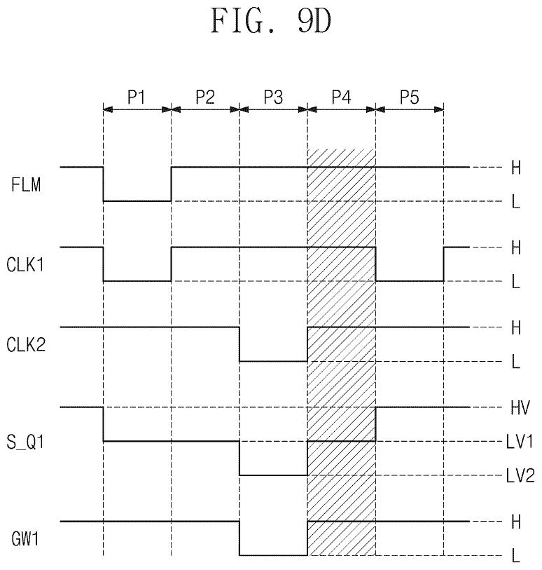

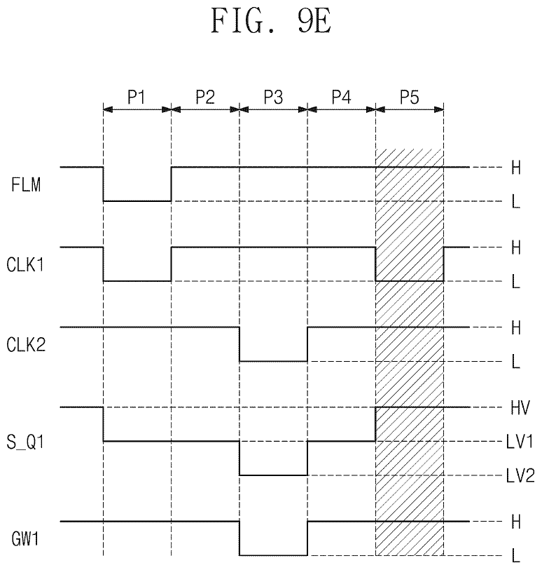

FIGS. 9A to 9E are timing diagrams for describing an operation of the driving stage ST1.

Referring to FIGS. 8A and 9A, during a first period P1, each of a carry signal (i.e., the start signal FLM) and the first clock signal CLK1 is at a low level L, and the second clock signal CLK2 is at a high level H.

When the first clock signal CLK1 is at the low level L, each of the first transistor M1 and the second transistor M2 is turned on.

Because the second transistor M2 is turned on, the scan signal GW1 of a high level H corresponding to the first voltage VGH may be output to the output terminal OUT.

In the meantime, because the first transistor M1 is turned on, the start signal FLM of the low level L may be transmitted to the first node Q1. Accordingly, a first signal S_Q1 of the first node Q1 may be a first low voltage level LV1 corresponding to the start signal FLM of the low level L.

When the first signal S_Q1 is at the first low voltage level LV1, the third transistor M3 may be turned on. As the third transistor M3 is turned on, the second clock signal CLK2, which is at the high level H, is output to the output terminal OUT through the third transistor M3. Accordingly, in a first period P1, the scan signal GW1 is at the high level H.

During the first period P1, the first voltage VGH, which is a DC voltage, may be delivered to the output terminal OUT through the second transistor M2. Accordingly, during the first period P1, the scan signal GW1 of the output terminal OUT may be maintained at a stable high level H.

Referring to FIGS. 8B and 9B, during a second period P2, each of the start signal FLM, the first clock signal CLK1, and the second clock signal CLK2 is at the high level H.

When the first clock signal CLK1 is at the high level H, each of the first transistor M1 and the second transistor M2 is turned off.

The first signal S_Q1 of the first node Q1 may be maintained at the first low voltage level LV1 by the second capacitor C2. Because the third transistor M3 remains turned on while the first signal S_Q1 remains at the first low voltage level LV1, the second clock signal CLK2, which is at the high level H, is output to the output terminal OUT through the third transistor M3. Accordingly, in the second period P2, the scan signal GW1 is at the high level H.

Referring to FIGS. 8C and 9C, during a third period P3, each of the start signal FLM and the first clock signal CLK1 is at the high level H, and the second clock signal CLK2 is at the low level L.

When the first clock signal CLK1 is at the high level H, each of the first transistor M1 and the second transistor M2 is turned off.

The first signal S_Q1 of the first node Q1 may be maintained at the first low voltage level LV1 by the second capacitor C2. Because the third transistor M3 remains turned on while the first signal S_Q1 remains at the first low voltage level LV1, the second clock signal CLK2, which is at the low level L, is output to the output terminal OUT through the third transistor M3. Accordingly, in the third period P3, the scan signal GW1 is at the low level L.

As the scan signal GW1 of the output terminal OUT transitions from the high level H to the low level L, the first signal S_Q1 of the first node Q1 may be changed to a second low voltage level LV2 lower than the first low voltage level LV1 by the first capacitor C1.

As the voltage level of the first signal S_Q1 becomes lower, the third transistor M3 may be completely turned on. Accordingly, in the third period P3, the scan signal GW1 may be maintained at the low level L of the second clock signal CLK2.

Referring to FIGS. 8D and 9D, during a fourth period P4, each of the start signal FLM, the first clock signal CLK1, and the second clock signal CLK2 is at the high level H.

When the first clock signal CLK1 is at the high level H, each of the first transistor M1 and the second transistor M2 is turned off.

When the third transistor M3 is turned on in the third period P3, and then the second clock signal CLK2 transitions from the low level L to the high level H in the fourth period P4, the second clock signal CLK2, which is at the high level H, is output to the output terminal OUT through the third transistor M3. Accordingly, in the fourth period P4, the scan signal GW1 is at the high level H.

As the scan signal GW1 of the output terminal OUT transitions from the low level L to the high level H, the first signal S_Q1 of the first node Q1 may be changed to the first low voltage level LV1 higher than the second low voltage level LV2 by the first capacitor C1.

Because the third transistor M3 remains turned on even though the voltage level of the first signal S_Q1 is changed to the first low voltage level LV1, the level of the scan signal GW1 may be equal to the high level H of the second clock signal CLK2 in the fourth period P4.

Referring to FIGS. 8E and 9E, during a fifth period P5, each of the start signal FLM and the second clock signal CLK2 is at the high level H, and the first clock signal CLK1 is at the low level L.

When the first clock signal CLK1 is at the low level L, each of the first transistor M1 and the second transistor M2 is turned on.

Because the first transistor M1 is turned on, the start signal FLM of the high level H may be transmitted to the first node Q1. Accordingly, the first signal S_Q1 of the first node Q1 may be at a high voltage level HV corresponding to the start signal FLM of the high level H.

When the first signal S_Q1 is at the high voltage level HV, the third transistor M3 may be turned off.

In the meantime, because the second transistor M2 is turned on, the scan signal GW1 of a high level H corresponding to the first voltage VGH may be output to the output terminal OUT. Accordingly, in the fifth period P5, the scan signal GW1 is at the high level H.

During the fifth period P5, the first voltage VGH, which is a DC voltage, may be delivered to the output terminal OUT. Accordingly, during the fifth period P5, the scan signal GW1 of the output terminal OUT may be maintained at the stable high level ‘H’.

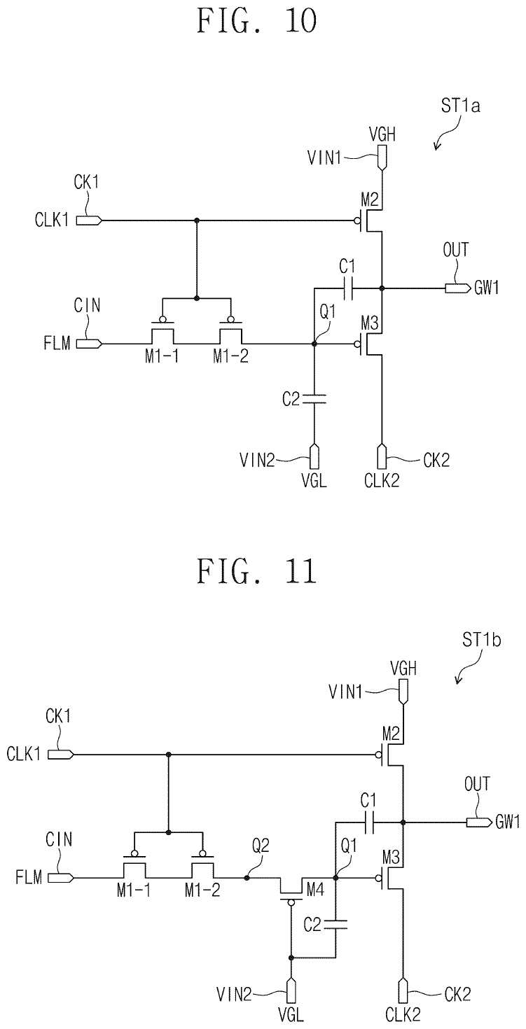

FIG. 10 is a circuit diagram of a driving stage ST1a, according to an embodiment of the present disclosure.

Referring to FIG. 10, the driving stage ST1a includes 1-1st, 1-2nd, second, and third transistors M1-1, M1-2, M2, and M3 and the first and second capacitors C1 and C2. The driving stage ST1a further includes the first and second clock input terminals CK1 and CK2, the carry input terminal CIN, the first and second voltage terminals VIN1 and VIN2, and the output terminal OUT.

The second and third transistors M2 and M3 and the first and second capacitors C1 and C2 of the driving stage ST1a are similar to the second and third transistors M2 and M3, and the first and second capacitors C1 and C2 of the driving stage ST1 shown in FIG. 7. Accordingly, the same reference numerals are used for components, which are similar to components in the driving stage ST1 shown in FIG. 7, and additional descriptions are omitted to avoid redundancy.

In an embodiment, an input circuit may include the 1-1st transistor M1-1 and the 1-2nd transistor M1-2.

The 1-1st transistor M1-1 and the 1-2nd transistor M1-2 are sequentially connected in series between the carry input terminal CIN and the first node Q1. The gate electrode of each of the 1-1st transistor M1-1 and the 1-2nd transistor M1-2 is connected to the first clock input terminal CK1.

As shown in FIGS. 9A to 9E, the first signal S_Q1 of the first node Q1 changes from the high voltage level HV to the second low voltage level LV2.

In particular, as shown in FIGS. 8C and 9C, in the third period P3, the start signal FLM is at the high level H (i.e., the high voltage level HV), and the first node Q1 is at the second low voltage level LV2. In this case, a voltage difference between the first electrode (i.e., a source electrode) and the second electrode (i.e., a drain electrode) of the first transistor M1 increases. Besides, as the voltage difference between the first and second electrodes of the first transistor M1 changes significantly periodically, the first transistor M1 may be damaged due to high stress.

As shown in FIG. 10, because the 1-1st transistor M1-1 and the 1-2nd transistor M1-2 are connected in series between the carry input terminal CIN and the first node Q1, the stress caused by the voltage difference between the first electrode and second electrode of each of the 1-1st transistor M1-1 and the 1-2nd transistor M1-2 may be reduced.

According to an embodiment of the present disclosure, damage to the 1-1st transistor M1-1 and the 1-2nd transistor M1-2 may be minimized, thereby improving the reliability of the driving stage ST1a.

FIG. 11 is a circuit diagram of a driving stage ST1b, according to an embodiment of the present disclosure.

Referring to FIG. 11, the driving stage ST1b includes 1-1st, 1-2nd, second, third, and fourth transistors M1-1, M1-2, M2, M3, and M4, and the first and second capacitors C1 and C2. The driving stage ST1b further includes the first and second clock input terminals CK1 and CK2, the carry input terminal CIN, the first and second voltage terminals VIN1 and VIN2, and the output terminal OUT.

The 1-1st, 1-2nd, second, and third transistors M1-1, M1-2, M2, and M3, and the first and the second capacitor C1 and C2 of the driving stage ST1b are similar to the 1-1st, 1-2nd, second, and third transistors M1-1, M1-2, M2, and M3, and the first and the second capacitor C1 and C2 of the driving stage ST1a shown in FIG. 10. Accordingly, the same reference numerals are used for components, which are similar to components in the driving stage ST1a shown in FIG. 10, and additional descriptions are omitted to avoid redundancy.

In an embodiment, the 1-1st transistor M1-1, the 1-2nd transistor M1-2, and the fourth transistor M4 may be included in an input circuit.

The 1-1st transistor M1-1 and the 1-2nd transistor M1-2 are sequentially connected in series between the carry input terminal CIN and a second node Q2. The gate electrode of each of the 1-1st transistor M1-1 and the 1-2nd transistor M1-2 is connected to the first clock input terminal CK1.

The fourth transistor M4 is connected between the second node Q2 and the first node Q1 and includes a gate electrode connected to the second voltage terminal VIN2.

The fourth transistor M4 may always be turned on by the second voltage VGL received at the gate electrode.

Because the 1-1st transistor M1-1, the 1-2nd transistor M1-2, and the fourth transistor M4 are connected in series between the carry input terminal CIN and the first node Q1, the stress caused by the voltage difference between the first electrode and second electrode of each of the 1-1st transistor M1-1, the 1-2nd transistor M1-2, and the fourth transistor M4 may be reduced.

According to this circuit configuration, damage to the 1-1st transistor M1-1, the 1-2nd transistor M1-2, and the fourth transistor M4 may be minimized, thereby improving the reliability of the driving stage ST1a.

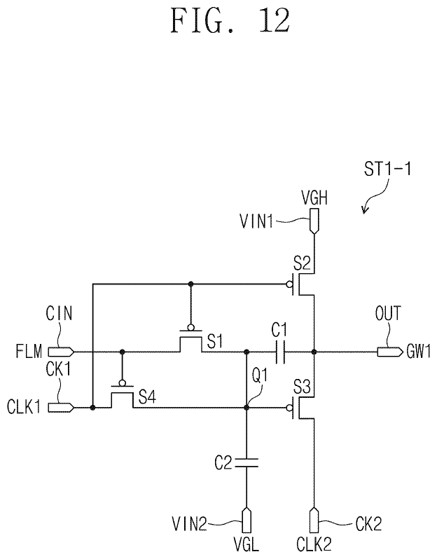

FIG. 12 is a circuit diagram of a driving stage ST1-1, according to an embodiment of the present disclosure.

Referring to FIG. 12, the driving stage ST1-1 includes first, second, third, and fourth transistors S1, S2, S3, and S4, and the first and second capacitors C1 and C2. The driving stage ST1-1 further includes the first and second clock input terminals CK1 and CK2, the carry input terminal CIN, the first and second voltage terminals VIN1 and VIN2, and the output terminal OUT.

The first, second, and third transistors S1, S2, and S3, the first capacitor C1, and the second capacitor C2 of the driving stage ST1-1 are similar to the first, second, and third transistors M1, M2, and M3, the first capacitor C1, and the second capacitor C2 of the driving stage ST1 shown in FIG. 7. Accordingly, additional descriptions are omitted to avoid redundancy.

The fourth transistor S4 is connected between the first clock input terminal CK1 and the first node Q1 and includes a gate electrode connected to the carry input terminal CIN. The first and fourth transistors S1 and S4 may be referred to as an input circuit.

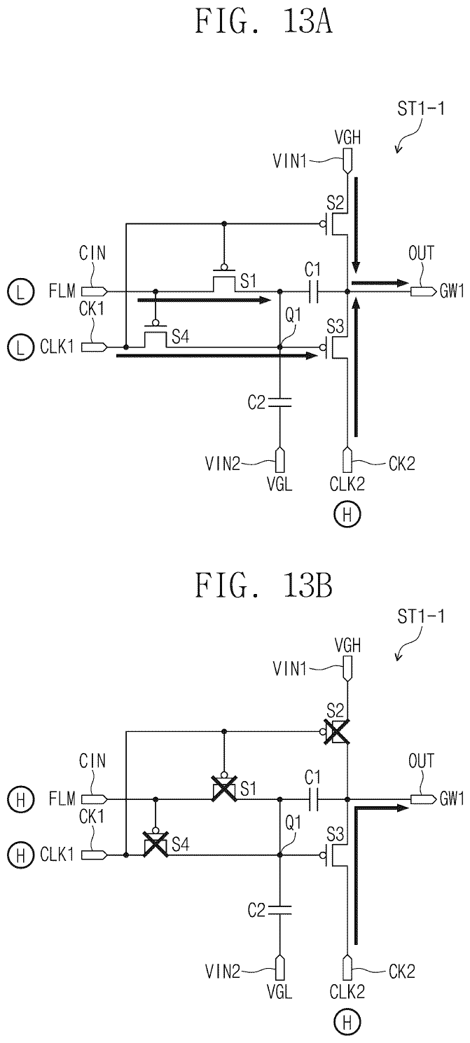

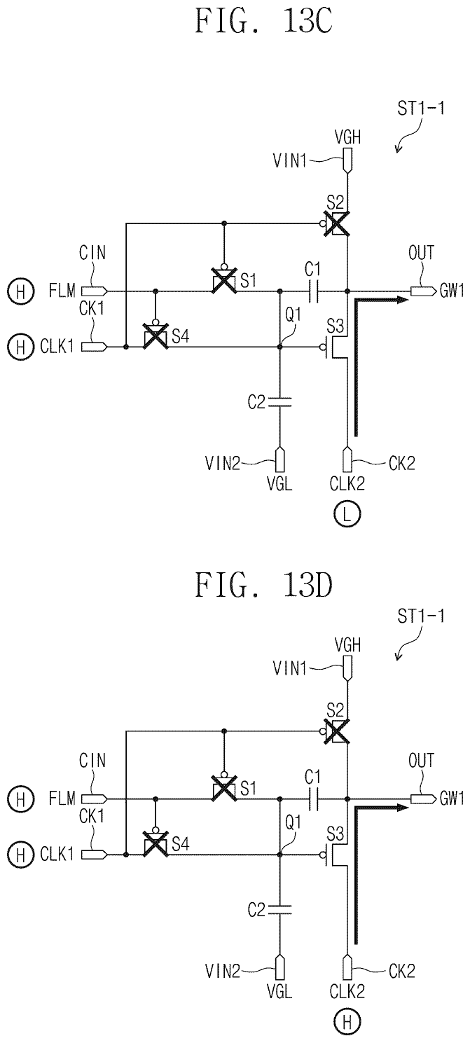

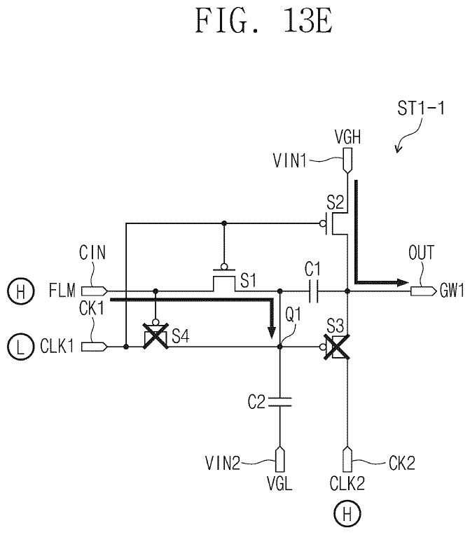

FIGS. 13A to 13E are circuit diagrams for describing an operation of the driving stage ST1-1.

Referring to FIGS. 9A and 13A, during a first period P1, each of a carry signal (i.e., the start signal FLM) and the first clock signal CLK1 is at the low level L, and the second clock signal CLK2 is at the high level H.

When the first clock signal CLK1 is at the low level L, each of the first transistor S1 and the second transistor S2 is turned on.

Because the second transistor S2 is turned on, the scan signal GW1 of the high level H corresponding to the first voltage VGH may be output to the output terminal OUT.

Because the first transistor S1 is turned on, the start signal FLM of the low level L may be transmitted to the first node Q1.

In the meantime, because the start signal FLM is at the low level L, the fourth transistor S4 is turned on. As the fourth transistor S4 is turned on, the clock signal CLK1 of the low level L may be transmitted to the first node Q1.

The first signal S_Q1 of the first node Q1 may be the first low voltage level LV1 corresponding to the start signal FLM of the low level L and the clock signal CLK1 of the low level L.

When the first signal S_Q1 is at the first low voltage level LV1, the third transistor S3 may be turned on. As the third transistor S3 is turned on, the second clock signal CLK2, which is at the high level H, is output to the output terminal OUT through the third transistor S3. Accordingly, in the first period P1, the scan signal GW1 is at the high level H.

During the first period P1, the first voltage VGH, which is a DC voltage, may be delivered to the output terminal OUT. Accordingly, during the first period P1, the scan signal GW1 of the output terminal OUT may be maintained at a stable high level H.

Referring to FIGS. 9B and 13B, during the second period P2, each of the start signal FLM, the first clock signal CLK1, and the second clock signal CLK2 is at the high level H. When the first clock signal CLK1 is at the high level H, each of the first transistor S1 and the second transistor S2 is turned off.

When the start signal FLM is at the high level H, the fourth transistor S4 is turned off.

The first signal S_Q1 of the first node Q1 may be maintained at the first low voltage level LV1 by the second capacitor C2. Because the third transistor S3 remains turned on while the first signal S_Q1 remains at the first low voltage level LV1, the second clock signal CLK2, which is at the high level H, is output to the output terminal OUT through the third transistor S3. Accordingly, in the second period P2, the scan signal GW1 is at the high level H.

Referring to FIGS. 9C and 13C, during the third period P3, each of the start signal FLM and the first clock signal CLK1 is at the high level H, and the second clock signal CLK2 is at the low level L.

When the first clock signal CLK1 is at the high level H, each of the first transistor S1 and the second transistor S2 is turned off.

When the start signal FLM is at the high level H, the fourth transistor S4 is turned off.

The first signal S_Q1 of the first node Q1 may be maintained at the first low voltage level LV1 by the second capacitor C2. Because the third transistor S3 remains turned on while the first signal S_Q1 remains at the first low voltage level LV1, the second clock signal CLK2, which is at the low level L, is output to the output terminal OUT through the third transistor S3. Accordingly, in the third period P3, the scan signal GW1 is at the low level L.

As the scan signal GW1 of the output terminal OUT transitions from the high level H to the low level L, the first signal S_Q1 of the first node Q1 may be changed to a second low voltage level LV2 lower than the first low voltage level LV1 by the first capacitor C1.

As the voltage level of the first signal S_Q1 becomes lower, the third transistor S3 may be completely turned on. Accordingly, in the third period P3, the scan signal GW1 may be maintained at the low level L of the second clock signal CLK2.

Referring to FIGS. 9D and 13D, during the fourth period P4, each of the start signal FLM, the first clock signal CLK1, and the second clock signal CLK2 is at the high level H.

When the first clock signal CLK1 is at the high level H, each of the first transistor S1 and the second transistor S2 is turned off.

When the start signal FLM is at the high level H, the fourth transistor S4 is turned off.

When the third transistor S3 is turned on in the third period P3, and then the second clock signal CLK2 transitions from the low level L to the high level H in the fourth period P4, the second clock signal CLK2, which is at the high level H, is output to the output terminal OUT through the third transistor S3. Accordingly, in the fourth period P4, the scan signal GW1 is at the high level H.

As the scan signal GW1 of the output terminal OUT transitions from the low level L to the high level H, the first signal S_Q1 of the first node Q1 may be changed to the first low voltage level LV1 higher than the second low voltage level LV2 by the first capacitor C1.

Because the third transistor S3 remains turned on even though the voltage level of the first signal S_Q1 is changed to the first low voltage level LV1, the level of the scan signal GW1 may be equal to the high level H of the second clock signal CLK2 in the fourth period P4.

Referring to FIGS. 9E and 13E, during the fifth period P5, each of the start signal FLM and the second clock signal CLK2 is at the high level H, and the first clock signal CLK1 is at the low level L.

When the first clock signal CLK1 is at the low level L, each of the first transistor S1 and the second transistor S2 is turned on.

When the start signal FLM is at the high level H, the fourth transistor S4 is turned off.

Because the first transistor S1 is turned on, the start signal FLM of the high level H may be transmitted to the first node Q1. Accordingly, the first signal S_Q1 of the first node Q1 may be at a high voltage level HV corresponding to the start signal FLM of the high level H.

When the first signal S_Q1 is at the high voltage level HV, the third transistor S3 may be turned off.

In the meantime, because the second transistor S2 is turned on, the scan signal GW1 of the high level H corresponding to the first voltage VGH may be output to the output terminal OUT. Accordingly, in the fifth period P5, the scan signal GW1 is at the high level H.

During the fifth period P5, the first voltage VGH, which is a DC voltage, may be delivered to the output terminal OUT. Accordingly, during the fifth period P5, the scan signal GW1 of the output terminal OUT may be maintained at the stable high level ‘H’.

A first electrode of the fourth transistor S4 is connected to the first clock input terminal CK1; a second electrode thereof is connected to the first node Q1; and a gate electrode thereof is connected to the carry input terminal CIN.

As shown in FIGS. 13B, 13C, and 13E, in each of the second, third, and fourth periods P2, P3, and P4, the first transistor SI and the fourth transistor S4 remain turned off. At this time, due to coupling capacitance formed between the gate electrode and the second electrode (i.e., the first node Q1) of the fourth transistor S4, the first signal S_Q1 of the first node Q1 may be more stably maintained at the first low voltage level LV1 and the second low voltage level LV2.

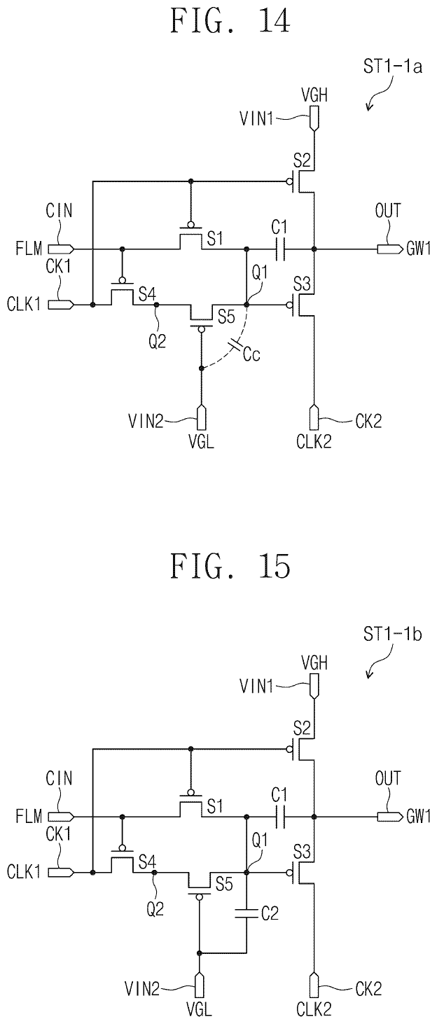

FIG. 14 is a circuit diagram of a driving stage ST1-la, according to an embodiment of the present disclosure.

Referring to FIG. 14, the driving stage ST1-la includes first second, third, fourth, and fifth transistors S1, S2, S3, S4, and S5, and the first capacitor C1. The driving stage ST1-1a further includes the first and second clock input terminals CK1 and CK2, the carry input terminal CIN, the first and second voltage terminals VIN1 and VIN2, and the output terminal OUT.

The first, second, third, and fourth transistors S1, S2, S3, and S4 and the first capacitor C1 of the driving stage ST1-1a are similar to the first, second, third, and fourth transistors S1, S2, S3, and S4, and the first capacitor C1 of the driving stage ST1-1 shown in FIG. 12. Accordingly, the same reference numerals are used for components, which are similar to components in the driving stage ST1-1 shown in FIG. 12, and additional descriptions are omitted to avoid redundancy.

The fourth transistor S4 includes a first electrode connected to the first clock input terminal CK1, a second electrode connected to the second node Q2, and a gate electrode connected to the carry input terminal CIN.

The fifth transistor S5 includes a first electrode connected to the second node Q2, a second electrode connected to the first node Q1, and a gate electrode connected to the second voltage terminal VIN2.

The driving stage ST1-1 shown in FIG. 12 includes the second capacitor C2. On the other hand, the driving stage ST1-1a shown in FIG. 14 does not include the second capacitor C2, but includes the fifth transistor S5. The first, second, and fifth transistors S1, S2, and S5 may be referred to as an input circuit.

Coupling capacitance Cc may be formed between the second electrode and the gate electrode of the fifth transistor S5. The coupling capacitance Cc between the second electrode and the gate electrode of the fifth transistor S5 may be the same as a capacitor being connected between the first node Q1 and the second voltage terminal VIN2. Accordingly, the first node Q1 may be stably maintained at a predetermined voltage level (i.e., the first low voltage level LV1 or the second low voltage level LV2) by the coupling capacitance Cc in each of the second, third, and fourth periods P2, P3, and P4 shown in FIGS. 9A to 9E.

In the meantime, the first signal S_Q1 of the first node Q1 has a great change from the high voltage level HV to the second low voltage level LV2.

As shown in FIGS. 9C and 13C, when during the third period P3, a signal having the high level H is provided to the first clock input terminal CK1 and the first node Q1 is at the second low voltage level LV2, a voltage difference between the first electrode and the second electrode of the fourth transistor S4 increases.

As shown in FIGS. 9E and 13E, when during the fifth period P5, a signal of the low level L is provided to the first clock input terminal CK1 and the first node Q1 is at the high voltage level HV, the voltage difference between the first and second electrodes of the fourth transistor S4 approaches 0.

As such, as the voltage difference between the first and second electrodes of the fourth transistor S4 changes significantly periodically, the fourth transistor S4 may be damaged due to high stress.

In the embodiment shown in FIG. 14, because the fourth transistor S4 and the fifth transistor S5 are sequentially connected in series between the first clock input terminal CK1 and the first node Q1, the stress caused by the voltage difference between the first electrode and second electrode of each of the fourth transistor S4 and the fifth transistor S5 may be reduced.

According to an embodiment of the present disclosure, damage to the fourth transistor S4 and the fifth transistor S5 may be minimized, thereby improving the reliability of the driving stage ST1-1a.

FIG. 15 is a circuit diagram of a driving stage ST1-1b, according to an embodiment of the present disclosure.

Referring to FIG. 15, the driving stage ST1-1b includes first second, third, fourth, and fifth transistors S1, S2, S3, S4, and S5, and the first and second capacitors C1 and C2. The driving stage ST1-1b further includes the first and second clock input terminals CK1 and CK2, the carry input terminal CIN, the first and second voltage terminals VIN1 and VIN2, and the output terminal OUT.

The first second, third, fourth, and fifth transistors S1, S2, S3, S4, and S5 and the first capacitor C1 of the driving stage ST1-1b are similar to the first second, third, fourth, and fifth transistors S1, S2, S3, S4, and S5, and the first capacitor C1 of the driving stage ST1-1a shown in FIG. 14. Accordingly, the same reference numerals are used for components, which are similar to components in the driving stage ST1-1a shown in FIG. 14, and additional descriptions are omitted to avoid redundancy.

The second capacitor C2 is connected between the first node Q1 and the second voltage terminal VIN2.

The driving stage ST1-1b may further include the second capacitor C2, and thus the first node Q1 may be stably maintained at a predetermined voltage level (i.e., the first low voltage level LV1 or the second low voltage level LV2) in each of the second, third, and fourth periods P2, P3, and P4 shown in FIGS. 9A to 9E.

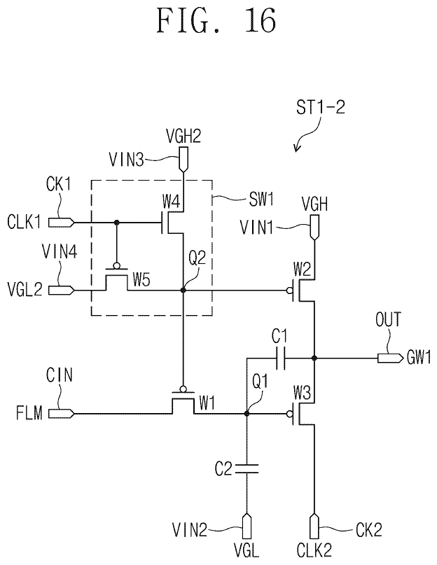

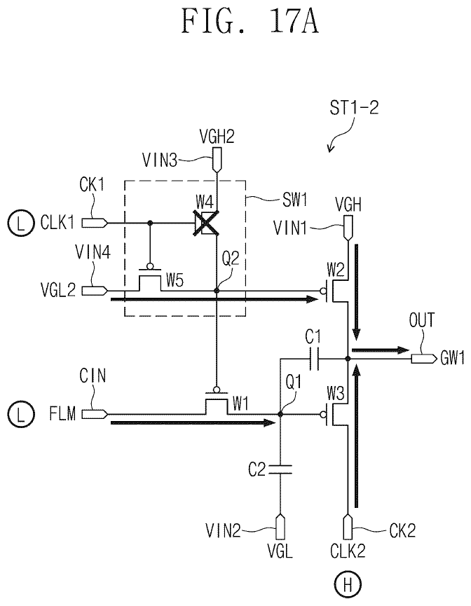

FIG. 16 is a circuit diagram of a driving stage ST1-2, according to an embodiment of the present disclosure.

Referring to FIG. 16, the driving stage ST1-2 includes first, second, and third transistors W1, W2, and W3, a switching circuit SW1, and the first and second capacitors C1 and C2. The driving stage ST1-2 further includes the first and second clock input terminals CK1 and CK2, the carry input terminal CIN, first to fourth voltage terminals VIN1, VIN2, VIN3, and VIN4, and the output terminal OUT.

The first, second, and third transistors W1, W2, and W3, the first capacitor C1, and the second capacitor C2 of the driving stage ST1-2 are similar to the first, second, and third transistors M1, M2, and M3, the first capacitor C1, and the second capacitor C2 of the driving stage ST1 shown in FIG. 7. Accordingly, additional descriptions are omitted to avoid redundancy.

An input circuit includes the first transistor W1 and the switching circuit SW1. The input circuit may operate in response to the clock signal CLK1 from the first clock input terminal CK1.

The switching circuit SW1 includes fourth and fifth transistors W4 and W5.

The fourth transistor W4 is connected between the third voltage terminal VIN3 and the second node Q2, and includes a gate electrode connected to the first clock input terminal CK1.

The fifth transistor W5 is connected between the fourth voltage terminal VIN4 and the second node Q2, and includes a gate electrode connected to the first clock input terminal CK1.

In an embodiment, the fourth transistor W4 is an N-type transistor, and the fifth transistor W5 is a P-type transistor. However, the present disclosure is not limited thereto.

In an embodiment, a third voltage VGH2 may be received at the third voltage terminal VIN3, and a fourth voltage VGL2 may be received at the fourth voltage terminal VIN4. In an embodiment, the third voltage VGH2 may be a voltage level higher than or equal to the first voltage VGH. In an embodiment, the fourth voltage VGL2 may be a voltage level lower than or equal to the second voltage VGL.

The third voltage VGH2 and the fourth voltage VGL2 may be provided from the voltage generator 500 shown in FIG. 2.

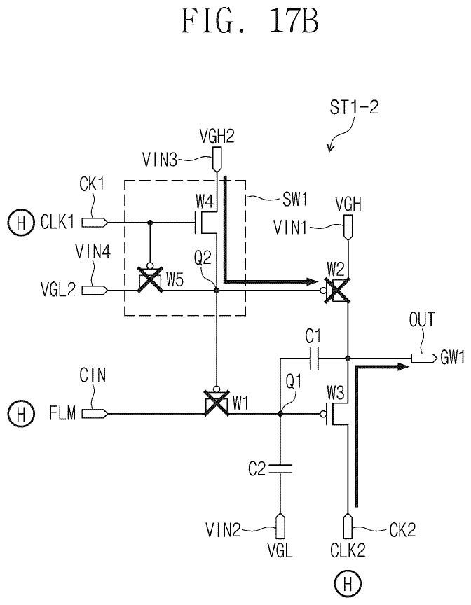

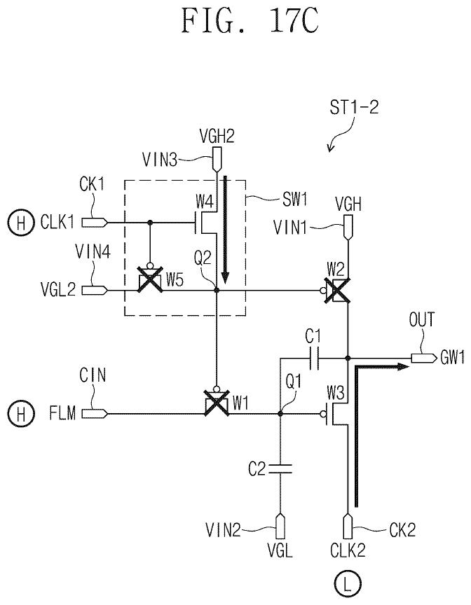

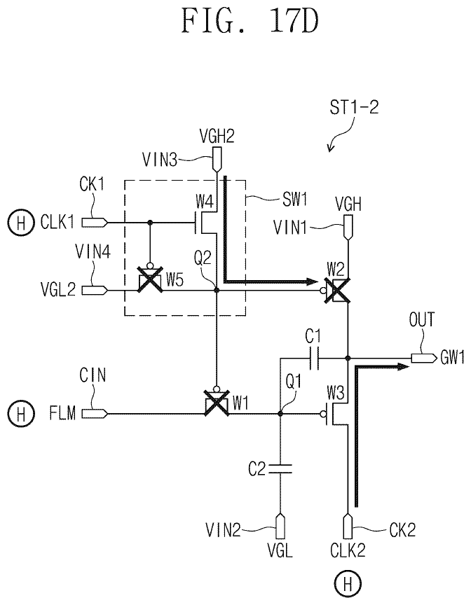

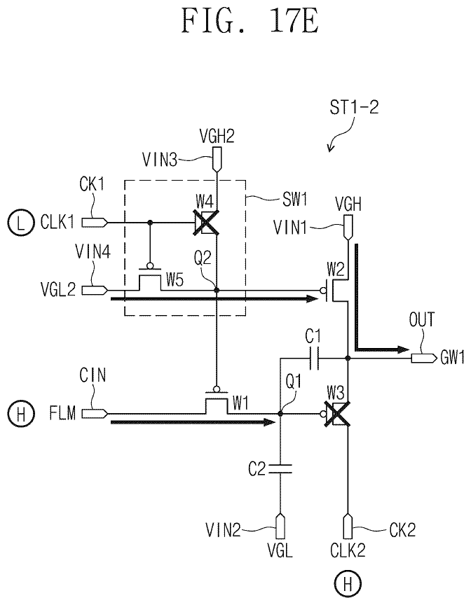

FIGS. 17A to 17E are circuit diagrams for describing an operation of the driving stage ST1-2.

Referring to FIGS. 9A and 17A, during a first period P1, each of a carry signal (i.e., the start signal FLM) and the first clock signal CLK1 is at the low level L, and the second clock signal CLK2 is at the high level H.

When the first clock signal CLK1 is at the low level L, the fourth transistor W4 is turned off and the fifth transistor W5 is turned on.

Because the fifth transistor W5 is turned on, the fourth voltage VGL2 is delivered to the second node Q2. Because the fourth voltage VGL2 is a lower voltage level than the second voltage VGL, the second transistor W2 is turned on. Accordingly, the scan signal GW1 of the high level H corresponding to the first voltage VGH may be output to the output terminal OUT.

In the meantime, because the first transistor W1 is turned on in response to the signal of the second node Q2, the start signal FLM of the low level L may be delivered to the first node Q1. Accordingly, a first signal S_Q1 of the first node Q1 may be the first low voltage level LVI corresponding to the start signal FLM of the low level L.

When the first signal S_Q1 is at the first low voltage level LV1, the third transistor W3 may be turned on. As the third transistor W3 is turned on, the second clock signal CLK2, which is at the high level H, is output to the output terminal OUT through the third transistor W3. Accordingly, in the first period P1, the scan signal GW1 is at the high level H.

During the first period P1, the first voltage VGH, which is a DC voltage, may be delivered to the output terminal OUT. Accordingly, during the first period P1, the scan signal GW1 of the output terminal OUT may be maintained at a stable high level H.

Referring to FIGS. 9B and 17B, during the second period P2, each of the start signal FLM, the first clock signal CLK1, and the second clock signal CLK2 is at the high level H.

When the first clock signal CLK1 is the high level H, the fourth transistor W4 is turned on, and the fifth transistor M5 is turned off.

As the fourth transistor W4 is turned on, the signal of the second node Q2 having the third voltage VGH2 higher than the first voltage VGH is delivered, and thus each of the first transistor W1 and the second transistor W2 is turned off.

The first signal S_Q1 of the first node Q1 may be maintained at the first low voltage level LV1 by the second capacitor C2. Because the third transistor W3 remains turned on while the first signal S_Q1 remains at the first low voltage level LV1, the second clock signal CLK2, which is at the high level H, is output to the output terminal OUT through the third transistor W3. Accordingly, in the second period P2, the scan signal GW1 is at the high level H.

Referring to FIGS. 9C and 17C, during the third period P3, each of the start signal FLM and the first clock signal CLK1 is at the high level H, and the second clock signal CLK2 is at the low level L.

When the first clock signal CLK1 is the high level H, the fourth transistor W4 is turned on, and the fifth transistor M5 is turned off.

As the fourth transistor W4 is turned on, the signal of the second node Q2 having the third voltage VGH2 higher than the first voltage VGH is delivered, and thus each of the first transistor W1 and the second transistor W2 remains turned off.

The first signal S_Q1 of the first node Q1 may be maintained at the first low voltage level LV1 by the second capacitor C2. Because the third transistor W3 remains turned on while the first signal S_Q1 remains at the first low voltage level LV1, the second clock signal CLK2, which is at the low level L, is output to the output terminal OUT through the third transistor W3. Accordingly, in the third period P3, the scan signal GW1 is at the low level L.

As the scan signal GW1 of the output terminal OUT transitions from the high level H to the low level L, the first signal S_Q1 of the first node Q1 may be changed to the second low voltage level LV2 lower than the first low voltage level LV1 by the first capacitor C1.

As the voltage level of the first signal S_Q1 becomes lower, the third transistor W3 may be completely turned on. Accordingly, in the third period P3, the scan signal GW1 may be maintained at the low level L of the second clock signal CLK2.

Referring to FIGS. 9D and 17D, during the fourth period P4, each of the start signal FLM, the first clock signal CLK1, and the second clock signal CLK2 is at the high level H.

When the first clock signal CLK1 is the high level H, the fourth transistor W4 is turned on, and the fifth transistor M5 is turned off.

When the third transistor W3 is turned on in the third period P3, and then the second clock signal CLK2 transitions from the low level L to the high level H in the fourth period P4, the second clock signal CLK2, which is at the high level H, is output to the output terminal OUT through the third transistor W3. Accordingly, in the fourth period P4, the scan signal GW1 is at the high level H.

As the scan signal GW1 of the output terminal OUT transitions from the low level L to the high level H, the first signal S_Q1 of the first node Q1 may be changed to the first low voltage level LV1 higher than the second low voltage level LV2 by the first capacitor C1.

Because the third transistor W3 remains turned on even though the voltage level of the first signal S_Q1 is changed to the first low voltage level LV1, the level of the scan signal GW1 may be equal to the high level H of the second clock signal CLK2 in the fourth period P4.

Referring to FIGS. 9E and 17E, during the fifth period P5, each of the start signal FLM and the second clock signal CLK2 is at the high level H, and the first clock signal CLK1 is at the low level L.

When the first clock signal CLK1 is at the low level L, the fourth transistor W4 is turned off and the fifth transistor M5 is turned on.

Because the fifth transistor W5 is turned on, the fourth voltage VGL2 is delivered to the second node Q2. Because the fourth voltage VGL2 is a lower voltage level than the second voltage VGL, the second transistor W2 is turned on. Accordingly, during the fifth period P5, the scan signal GW1 of the high level H corresponding to the first voltage VGH may be output to the output terminal OUT.

Meanwhile, because the first transistor W1 is turned on in response to the signal of the second node Q2, the start signal FLM of the high level H may be delivered to the first node Q1. Accordingly, the first signal S_Q1 of the first node Q1 may be at the high voltage level HV corresponding to the start signal FLM of the high level H.

Because the first signal S_Q1 of the first node Q1 is the high voltage level HV, the third transistor W3 is turned off.

As shown in FIGS. 9E and 17E, when the first clock signal CLK1 is at the low level L in the fifth period P5, the fifth transistor W5 is turned on, and thus the second node Q2 may be stably maintained at the fourth voltage VGL2. Accordingly, the second transistor W2 remains turned on, and thus the scan signal GW1 of the high level H corresponding to the first voltage VGH may be stably output to the output terminal OUT. In particular, because the fourth voltage VGL2 is a lower voltage level than the second voltage VGL, the second transistor W2 may remain completely turned on.

Moreover, the first transistor W1 may also be completely turned on in response to the signal of the second node Q2, the third transistor W3 may stably remain turned off.

The second transistor T2 of the pixel PX shown in FIG. 3 operates in response to the scan signal GWi. When the voltage level of the scan signal GWi is unstable in a section where the second transistor T2 needs to remain turned off, the data signal Dj delivered to the data line DLj is delivered to the pixel PX, and thus a desired image may be displayed.

As shown in FIG. 17E, in the fifth period P5, the second transistor W2 remains completely turned on, and thus the scan signal GW1 may be stably maintained at the high level HV corresponding to the first voltage VGH. Accordingly, the reliability of the display device DD may be improved.

In the meantime, as shown in FIGS. 17B, 17C, and 17D, when the first clock signal CLK1 is at the high level H in each of the second, third, and fourth periods P2, P3, and P4, the fourth transistor W4 is turned on. As the fourth transistor W4 is turned on, the signal of the second node Q2 having the third voltage VGH2 higher than the first voltage VGH is delivered, and thus each of the first transistor W1 and the second transistor W2 is completely turned off.

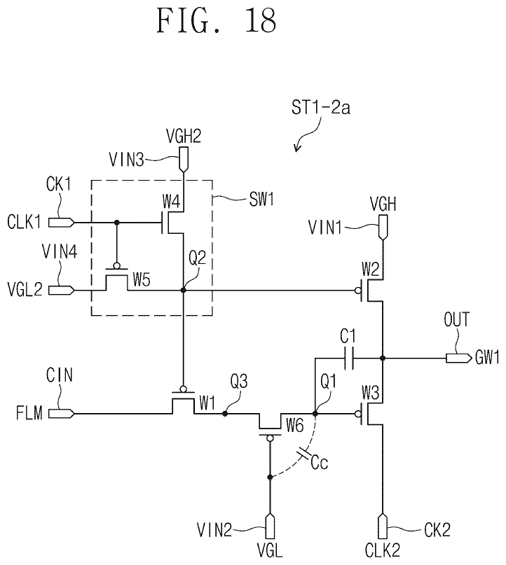

FIG. 18 is a circuit diagram of a driving stage ST1-2a, according to an embodiment of the present disclosure.

Referring to FIG. 18, the driving stage ST1-2a includes first second, third, and sixth transistors W1, W2, W3, and W6, the switching circuit SW1, and the first capacitor C1. The driving stage ST1-2a further includes the first and second clock input terminals CK1 and CK2, the carry input terminal CIN, first to fourth voltage terminals VIN1, VIN2, VIN3, and VIN4, and the output terminal OUT.

The first, second, and third transistors W1, W2, and W3, the switching circuit SW1, and the first capacitor C1 of the driving stage ST1-2a are similar to the first, second, and third transistors W1, W2, and W3, the switching circuit SW1, and the first capacitor C1 of the driving stage ST1-2 shown in FIG. 16. Accordingly, the same reference numerals are used for components, which are similar to components in the driving stage ST1-2 shown in FIG. 16, and additional descriptions are omitted to avoid redundancy.

The input circuit includes the first transistor W1, the sixth transistor W6, and the switching circuit SW1. The input circuit may operate in response to the clock signal CLK1 from the first clock input terminal CK1. The switching circuit SW1 includes fourth and fifth transistors W4 and W5. In an embodiment, the fourth transistor W4 is an N-type transistor, and the fifth transistor W5 is a P-type transistor. However, the present disclosure is not limited thereto.

The first transistor W1 includes a first electrode connected to the carry input terminal CIN, a second electrode connected to a third node Q3, and a gate electrode connected to the second node Q2.

The fifth transistor W6 includes a first electrode connected to the third node Q3, a second electrode connected to the first node Q1, and a gate electrode connected to the second voltage terminal VIN2.

The driving stage ST1-2 shown in FIG. 16 includes the second capacitor C2. On the other hand, the driving stage ST1-2a shown in FIG. 18 does not include the second capacitor C2, but includes the sixth transistor W6.

Coupling capacitance Cc may be formed between the second electrode and the gate electrode of the fifth transistor W6. The coupling capacitance Cc between the second electrode and the gate electrode of the sixth transistor W6 may be the same as a capacitor connected between the first node Q1 and the second voltage terminal VIN2. Accordingly, the first node Q1 may be stably maintained at a predetermined voltage level (i.e., the first low voltage level LV1 or the second low voltage level LV2) by the coupling capacitance Cc in each of the second, third, and fourth periods P2, P3, and P4 shown in FIGS. 9A to 9E.

In the meantime, the first signal S_Q1 of the first node Q1 has a great change from the high voltage level HV to the second low voltage level LV2.

As shown in FIGS. 9C and 17C, when during the third period P3, a signal of the high level H is provided to the carry input terminal CIN and the first node Q1 is at the second low voltage level LV2, a voltage difference between the first electrode and the second electrode of the first transistor W1 increases.

As shown in FIGS. 9E and 17E, when during the fifth period P5, a signal of the high level H is provided to the first clock input terminal CK1 and the first node Q1 is at the high voltage level HV, the voltage difference between the first and second electrodes of the first transistor W1 approaches 0.

As such, as the voltage difference between the first and second electrodes of the first transistor W1 changes significantly periodically, the first transistor W1 may be damaged due to high stress.

In an embodiment shown in FIG. 18, because the first transistor W1 and the sixth transistor W6 are sequentially connected in series between the carry input terminal CIN and the first node Q1, the stress caused by the voltage difference between the first electrode and second electrode of each of the first transistor W1 and the sixth transistor W6 may be reduced.

According to an embodiment of the present disclosure, damage to the first transistor W1 and the sixth transistor W6 may be minimized, thereby improving the reliability of the driving stage ST1-2a.

In an embodiment, the driving stage ST1-2a may further include a second capacitor connected between the first node Q1 and the second voltage terminal VIN2.

FIG. 19 is a circuit diagram of a driving stage ST1-3, according to an embodiment of the present disclosure.

Referring to FIG. 19, the driving stage ST1-3 includes second and third transistors Y2 and Y3, an input circuit INC, and the first capacitor C1. The driving stage ST1-3 further includes the first and second clock input terminals CK1 and CK2, the carry input terminal CIN, the first and second voltage terminals VIN1 and VIN2, and the output terminal OUT.

The second and third transistors Y2 and Y3 and the first capacitor C1 of the driving stage ST1-3 are similar to the second and third transistors M2 and M3 and the first capacitor C1 of the driving stage ST1 shown in FIG. 7. Accordingly, additional descriptions are omitted to avoid redundancy.

The input circuit INC includes the first, fourth, and fifth transistors Y1, Y4, and Y5.

The first transistor Y1 is connected between the second node Q2 and the second voltage terminal VIN2 and includes a gate electrode connected to the carry input terminal CIN.

The fourth transistor Y4 is connected between the carry input terminal CIN and the second node Q2, and includes a gate electrode connected to the first clock input terminal CK1.

The fifth transistor Y5 is connected between the second node Q2 and the first node Q1 and includes a gate electrode connected to the second voltage terminal VIN2.

In an embodiment, the driving stage ST1-3 may further include a second capacitor connected between the first node Q1 and the second voltage terminal VIN2.

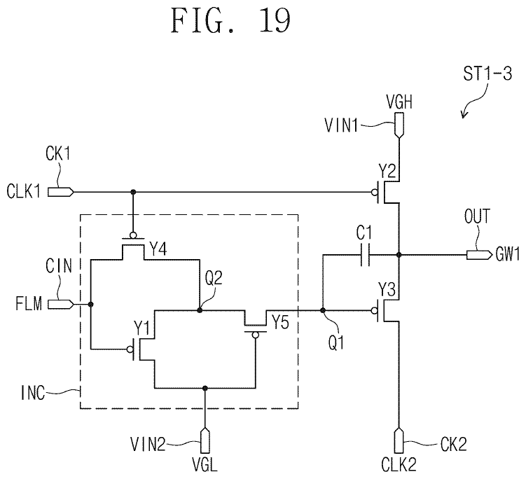

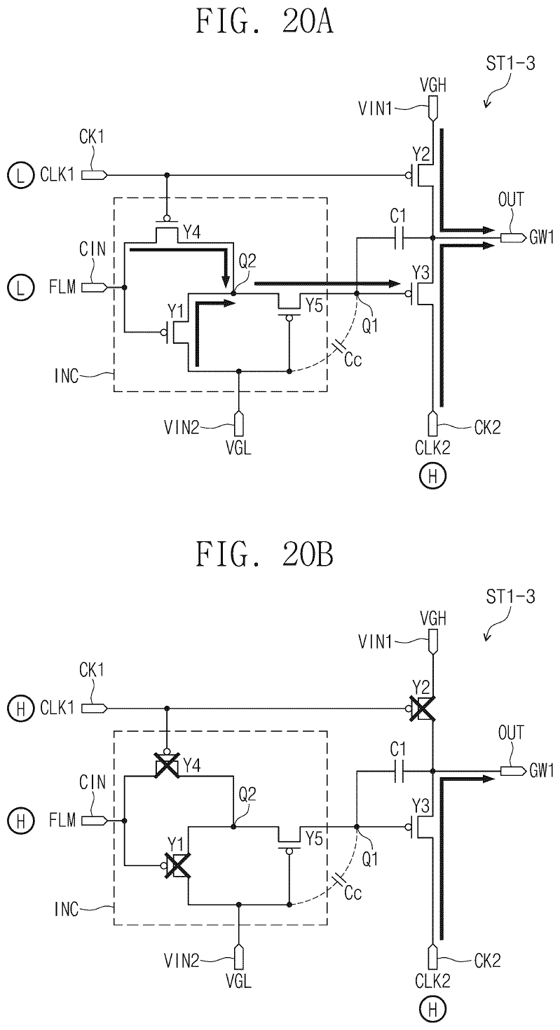

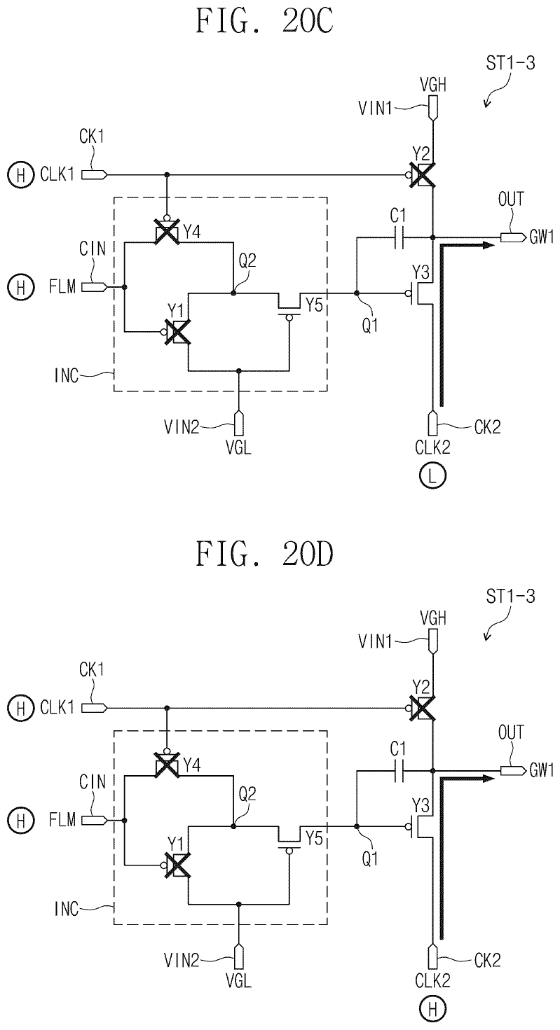

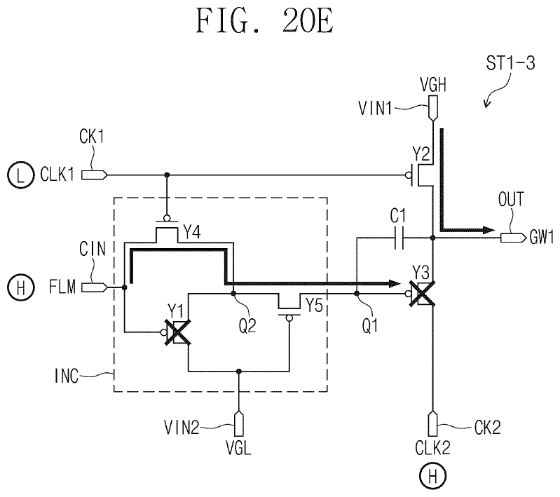

FIGS. 20A to 20E are circuit diagrams for describing an operation of the driving stage ST1-3.

Referring to FIGS. 9A and 20A, during a first period P1, each of a carry signal (i.e., the start signal FLM) and the first clock signal CLK1 is at the low level L, and the second clock signal CLK2 is at the high level H.

When the first clock signal CLK1 is at the low level L, each of the second transistor Y2 and the fourth transistor Y4 is turned on.

Because the second transistor Y2 is turned on, the scan signal GW1 of a high level H corresponding to the first voltage VGH may be output to the output terminal OUT. Moreover, because the fourth transistor Y4 is turned on, the start signal FLM of the low level L may be transmitted to the second node Q2.

When the start signal FLM is at the low level L, the first transistor Y1 is turned on. Accordingly, the second voltage VGL may be transmitted to the second node Q2 through the first transistor Y1.

Because the fifth transistor Y5 is always turned on, the first signal S_Q1 of the first node Q1 may be the first low voltage level LV1 corresponding to the second voltage VGL.

During the first period P1, the first voltage VGH, which is a DC voltage, may be delivered to the output terminal OUT through the second transistor Y2. Accordingly, during the first period P1, the scan signal GW1 of the output terminal OUT may be maintained at a stable high level H.

Furthermore, during the first period P1, the second voltage VGL, which is a DC voltage, may be delivered to the first node Q1 through the fifth transistor Y5. Accordingly, during the first period P1, the third transistor Y3 remains turned on, and the second clock signal CLK2 of the high level H may be output as the scan signal GW1 of the output terminal OUT.

Referring to FIGS. 9B and 20B, during the second period P2, each of the start signal FLM, the first clock signal CLK1, and the second clock signal CLK2 is at the high level H.

When the first clock signal CLK1 is at the high level H, each of the second transistor Y2 and the fourth transistor Y4 is turned off.

When the start signal FLM is at the high level H, the first transistor Y1 is turned off.

The coupling capacitance Cc may be formed between the second electrode and the gate electrode of the fifth transistor Y5, that is, between the first node Q1 and the second voltage terminal VIN2.

The first signal S_Q1 of the first node Q1 may be maintained at the first low voltage level LV1 by the coupling capacitance Cc. Because the third transistor Y3 remains turned on while the first signal S_Q1 remains at the first low voltage level LV1, the second clock signal CLK2, which is at the high level H, is output to the output terminal OUT through the third transistor Y3. Accordingly, in the second period P2, the scan signal GW1 is at the high level H.

Referring to FIGS. 9C and 20C, during the third period P3, each of the start signal FLM and the first clock signal CLK1 is at the high level H, and the second clock signal CLK2 is at the low level L.

When the first clock signal CLK1 is at the high level H, each of the second transistor Y2 and the fourth transistor Y4 is turned off.

When the start signal FLM is at the high level H, the first transistor Y1 is turned off.

The coupling capacitance Cc may be formed between the second electrode and the gate electrode of the fifth transistor Y5, that is, between the first node Q1 and the second voltage terminal VIN2.

The first signal S_Q1 of the first node Q1 may be maintained at the first low voltage level LV1 by the coupling capacitance Cc. Because the third transistor Y3 remains turned on while the first signal S_Q1 remains at the first low voltage level LV1, the second clock signal CLK2, which is at the low level L, is output to the output terminal OUT through the third transistor Y3. Accordingly, in the third period P3, the scan signal GW1 is at the low level L.

As the scan signal GW1 of the output terminal OUT transitions from the high level H to the low level L, the first signal S_Q1 of the first node Q1 may be changed to the second low voltage level LV2 lower than the first low voltage level LV1 by the first capacitor C1.

As the voltage level of the first signal S_Q1 becomes lower, the third transistor Y3 may be completely turned on. Accordingly, in the third period P3, the scan signal GW1 may be maintained at the low level L of the second clock signal CLK2.

Referring to FIGS. 9D and 20D, during the fourth period P4, each of the start signal FLM, the first clock signal CLK1, and the second clock signal CLK2 is at the high level H.

When the first clock signal CLK1 is at the high level H, each of the second transistor Y2 and the fourth transistor Y4 is turned off.

When the start signal FLM is at the high level H, the first transistor Y1 is turned off.

When the third transistor Y3 is turned on in the third period P3, and then the second clock signal CLK2 transitions from the low level L to the high level H in the fourth period P4, the second clock signal CLK2, which is at the high level H, is output to the output terminal OUT through the third transistor Y3. Accordingly, in the fourth period P4, the scan signal GW1 is at the high level H.

As the scan signal GW1 of the output terminal OUT transitions from the low level L to the high level H, the first signal S_Q1 of the first node Q1 may be changed to the first low voltage level LV1 higher than the second low voltage level LV2 by the first capacitor C1.

Because the third transistor M3 remains turned on even though the voltage level of the first signal S_Q1 is changed to the first low voltage level LV1, the level of the scan signal GW1 may be equal to the high level H of the second clock signal CLK2 in the fourth period P4.

Referring to FIGS. 9E and 20E, during the fifth period P5, each of the start signal FLM and the second clock signal CLK2 is at the high level H, and the first clock signal CLK1 is at the low level L.

When the first clock signal CLK1 is at the low level L, each of the second transistor Y2 and the fourth transistor Y4 is turned on.

When the start signal FLM is at the high level H, the first transistor Y1 is turned off.

Because the first transistor Y4 is turned on, the start signal FLM of the high level H may be transmitted to the first node Q1 through the fourth transistor Y4 and the fifth transistor Y5. Accordingly, the first signal S_Q1 of the first node Q1 may be at the high voltage level HV corresponding to the start signal FLM of the high level H. When the first signal S_Q1 is at the high voltage level HV, the third transistor Y3 may be turned off.

In the meantime, because the second transistor Y2 is turned on, the scan signal GW1 of the high level H corresponding to the first voltage VGH may be output to the output terminal OUT. Accordingly, in the fifth period P5, the scan signal GW1 is at the high level H.

During the fifth period P5, the first voltage VGH, which is a DC voltage, may be delivered to the output terminal OUT. Accordingly, during the fifth period P5, the scan signal GW1 of the output terminal OUT may be maintained at the stable high level ‘H’.

Although embodiments of the present disclosure have been described for illustrative purposes, those skilled in the art will appreciate that various modifications, and substitutions are possible, without departing from the scope and spirit of the present disclosure as disclosed in the accompanying claims. Accordingly, the technical scope of the present disclosure is not limited to the detailed description of this specification, but should be defined by the claims.

According to embodiments of the present disclosure, a scan driving circuit including the minimum number of transistors may be implemented. Accordingly, a circuit area of the scan driving circuit may be minimized. As the circuit area of the scan driving circuit is minimized, the bezel area of the display device may be minimized.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A scan driving circuit comprising:
an input circuit connected between a carry input terminal and a first node and configured to operate in response to a first clock signal received through a first clock input terminal;
a second transistor connected between a first voltage terminal and an output terminal and including a gate electrode connected to the first clock input terminal;
a third transistor connected between the output terminal and a second clock input terminal and including a gate electrode connected to the first node;
a first capacitor connected between the output terminal and the first node; and
a second capacitor connected between the first node and a second voltage terminal.

2. The scan driving circuit of claim 1, wherein a first voltage provided to the first voltage terminal has a higher voltage level than a second voltage provided to the second voltage terminal.

3. The scan driving circuit of claim 1, wherein a first clock signal provided to the first clock input terminal and a second clock signal provided to the second clock input terminal have frequencies the same as each other and different phases from each other.

4. The scan driving circuit of claim 3, wherein during a first period, each of a carry signal provided to the carry input terminal and the first clock signal is at a first level,
wherein during a second period different from the first period, the second clock signal is at the first level, and
wherein a scan signal output to the output terminal during the second period is at the first level the same as the second clock signal.

5. The scan driving circuit of claim 1, wherein the input circuit is connected between the carry input terminal and the first node, and includes a gate electrode connected to the first clock input terminal.

6. The scan driving circuit of claim 1, wherein the input circuit includes:
1-1st and 1-2nd transistors, which are sequentially connected in series between the carry input terminal and the first node, and each of which includes a gate electrode connected to the first clock input terminal.

7. The scan driving circuit of claim 1, wherein the input circuit further includes:
1-1st and 1-2nd transistors, which are sequentially connected in series between the carry input terminal and a second node, and each of which includes a gate electrode connected to the first clock input terminal; and
a fourth transistor connected between the first node and the second node and including a gate electrode connected to the second voltage terminal.

8. The scan driving circuit of claim 1, further comprising:
a fourth transistor connected between the first clock input terminal and the first node and includes a gate electrode connected to the carry input terminal.

9. The scan driving circuit of claim 1, further comprising:
a fourth transistor connected between the first clock input terminal and a second node and including a gate electrode connected to the carry input terminal; and
a fifth transistor connected between the second node and the first node and including a gate electrode connected to the second voltage terminal.

10. The scan driving circuit of claim 1, wherein the input circuit includes:
a first transistor connected between the carry input terminal and the first node and including a gate electrode connected to a second node;
a fourth transistor connected between a third voltage terminal and the second node and including a gate electrode connected to the first clock input terminal; and
a fifth transistor connected between a fourth voltage terminal and the second node and including a gate electrode connected to the first clock input terminal.

11. The scan driving circuit of claim 10, wherein a first voltage provided to the first voltage terminal has a higher voltage level than a second voltage provided to the second voltage terminal,
wherein a third voltage provided to the third voltage terminal has a higher voltage level than the first voltage, and
wherein a fourth voltage provided to the fourth voltage terminal has a voltage level lower than the second voltage.

12. The scan driving circuit of claim 1, wherein the input circuit includes:
a first transistor connected between the carry input terminal and a third node and including a gate electrode connected to a second node;
a fourth transistor connected between a third voltage terminal and the second node and including a gate electrode connected to the first clock input terminal;
a fifth transistor connected between a fourth voltage terminal and the second node and including a gate electrode connected to the first clock input terminal; and
a sixth transistor connected between the third node and the first node and including a gate electrode connected to the second voltage terminal.

13. The scan driving circuit of claim 12, wherein a first voltage provided to the first voltage terminal has a higher voltage level than a second voltage provided to the second voltage terminal,
wherein a third voltage provided to the third voltage terminal has a higher voltage level than the first voltage, and
wherein a fourth voltage provided to the fourth voltage terminal has a voltage level lower than the second voltage.

14. The scan driving circuit of claim 1, wherein the input circuit includes:
a first transistor connected between a second node and the second voltage terminal and including a gate electrode connected to the carry input terminal;
a fourth transistor connected between the carry input terminal and the second node and including a gate electrode connected to the first clock input terminal; and
a fifth transistor connected between the second node and the first node and including a gate electrode connected to the second voltage terminal.

15. A display device comprising:
a display panel including a pixel;
a scan driving circuit configured to provide a scan signal to the pixel;
a driving controller configured to provide a start signal, a first clock signal, and a second clock signal to the scan driving circuit; and
a voltage generator configured to provide a first voltage and a second voltage to the scan driving circuit,
wherein the scan driving circuit includes:
an input circuit connected between a carry input terminal configured to receive the start signal and a first node, and configured to operate in response to a first clock signal received through a first clock input terminal;
a second transistor connected between a first voltage terminal configured to receive the first voltage and an output terminal configured to output the scan signal, and including a gate electrode connected to the first clock input terminal;
a third transistor connected between the output terminal and the second clock input terminal configured to receive the second clock signal, and including a gate electrode connected to the first node;
a first capacitor connected between the output terminal and the first node; and
a second capacitor connected between the first node and a second voltage terminal configured to receive the second voltage.

16. The display device of claim 15, wherein during a first period, each of the start signal and the first clock signal is at a first level,
wherein during a second period different from the first period, the second clock signal is at the first level, and
wherein during the second period, the scan signal is at the first level the same as the second clock signal.

17. The display device of claim 15, wherein the input circuit is connected between the carry input terminal and the first node, and includes a gate electrode connected to the first clock input terminal.

18. The display device of claim 15, further comprising:
a fourth transistor is connected between the first clock input terminal and the first node and includes a gate electrode connected to the carry input terminal.

19. The display device of claim 15, wherein the input circuit includes:
a first transistor connected between the carry input terminal and the first node and including a gate electrode connected to a second node;
a fourth transistor connected between a third voltage terminal and the second node and including a gate electrode connected to the first clock input terminal; and
a fifth transistor connected between a fourth voltage terminal and the second node and including a gate electrode connected to the first clock input terminal.

20. The display device of claim 15, further comprising:
a data driving circuit configured to provide a data signal,
wherein the pixel includes:
a light emitting element;
a first pixel transistor including a first electrode, a second electrode connected to the light emitting element, and a gate electrode; and
a second pixel transistor connected between a data line configured to receive the data signal and the first electrode of the first transistor and including a gate electrode configured to receive the scan signal.
